(19) United States
(12) Patent Application Publication
(10) Pub. No.: US 2011/0087559 A1
(43) Pub. Date: Apr. 14, 2011

(54) Compliance Assurance System

(76) Inventors: Gil Paul, Edison, NJ (US); Stewart Paul, Princeton Junction, NJ (US)

(21) Appl. No.: 12/901,528

(22) Filed: Oct. 9, 2010

Related U.S. Application Data
(60) Provisional application No. 61/278,629, filed on Oct. 9, 2009.
(60) Provisional application No. 61/284,096, filed on Dec. 14, 2009.
(60) Provisional application No. 61/358,150, filed on Jun. 24, 2010.

(51) Int. Cl. G06Q 30/00; G06F 15/173; H04N 7/173; H04N 7/18

(52) U.S. Cl. 705/26.81; 709/224; 725/93; 348/159; 705/26.82; 348/E07.085

(57) ABSTRACT

A system including an image system located at a client facility for observing a facility. A surveillance system is in network communication with the image system and located at the facility to be observed. A compliance assurance system has a server independent of, but in network communication with the client facility and facility to be observed, wherein shared rights for scheduling observation times between the client facility and the facility to be observed are coordinated through the compliance assurance system.

### CROSS-REFERENCE TO RELATED APPLICATION(S)

This application claims the benefit of U.S. Provisional Application Ser. No. 61/287,629 filed on Oct. 9, 2009, U.S. Provisional Application Ser. No. 61/284,096 filed on Dec. 14, 2009 and U.S. Provisional Application Ser. No. 61/358,150 filed on Jun. 24, 2010, each of which is hereby incorporated in its entirety by reference.

### BACKGROUND OF THE INVENTION

1. Field of the Invention

This invention relates generally to a system for monitoring compliance of a manufacturer with manufacturing requirements, more particularly, to a compliance assurance system for monitoring a supplier's manufacturing facility during a production run.

2. Description of the Related Art

With the advent of modern decentralized manufacturing environments, the need exists for remote condition monitoring in such environments in which manufacturing facilities may service multiple clients and client production may cover more than one such manufacturing facility. While remote condition monitoring assures manufacturer compliance by the client, such monitoring often requires coordination between the client and the manufacturer to ensure surveillance does not overlap with other clients, but may occur at times desirable by the client for observing certain aspects during certain stages of manufacture. Such environments are not well suited to currently existing surveillance systems as surveillance at times desired by one or more clients needs to be coordinated with one or more manufacturing facilities. A need exists for a way to ensure surveillance times between independent entities where a client and manufacturer relationship exists while ensuring confidentiality of other client and manufacturer relationships that may exist. Such surveillance times should account for desired events or times during production chosen by the client. Such surveillance times should also allow for the manufacturer to confirm or deny surveillance times such as when a desired time conflicts with another client or would occur at a time in which an event that it is desirable to observe is not scheduled. Furthermore, it is desirable that such surveillance information be accessible by the client related to the job worked by the manufacturer during the surveillance, but not to other third parties.

### SUMMARY OF THE INVENTION

The present invention relates to a system including an image system located at a client facility for observing a facility. A surveillance system is in network communication with the image system and located at a facility to be observed. A compliance assurance system has a server independent of, but in network communication with the client facility and facility to be observed, wherein shared rights for scheduling observation times between the client facility and the facility to be observed are coordinated through the compliance assurance system.

The compliance assurance system includes a database for tracking the information related to the image system and the surveillance system including video availability and recording times.

The compliance assurance system includes an engine for authenticating and authorizing new surveillance requests from said at least one image system and requesting an acceptance or rejection from the surveillance system for such requests.

The compliance assurance system further includes a merchant management engine for setting up and authorizing at least one image system for at least one client facility.

The compliance assurance system further includes a manufacturer management engine for setting up and authorizing at least one surveillance system for at least one facility to be observed.

The compliance assurance system further includes a manufacturer link/unlink engine for authorizing communication between at least one image system for at least one client facility and at least one surveillance system for at least one facility to be observed.

### BRIEF DESCRIPTION OF THE DRAWINGS

Other aspects, advantages and novel features of the invention will become more apparent from the following detailed description of the invention when considered in conjunction with the accompanying drawings wherein:

FIG. 1 is a block diagram of a manufacturing compliance system according to the present invention;

FIG. 2 is a block diagram of a merchant imaging system according to FIG. 1;

FIG. 3 is a block diagram of a compliance assurance system according to FIG. 1;

FIG. 4 is a block diagram of a manufacturing surveillance system according to FIG. 1;

FIG. 5 is a flow chart for the user login engine of FIG. 2;

FIG. 6a-b is a flow chart for the New Appointment Request Engine of FIG. 2;

FIG. 7 is a flow chart for the Live Streaming Management Engine of FIG. 2;

FIG. 8 is a flow chart for the VOD Management Engine of FIG. 2;

FIG. 9 is a login screen for the MIS server of FIG. 2;

FIG. 10 is an options menu for the MIS server of FIG. 2;

FIG. 11 is a new appointment data request screen for the MIS server of FIG. 2;

FIG. 12 is a live streaming video request screen for the MIS server of FIG. 2;

FIG. 13 is a Video On Demand (VOD) video request screen for the MIS server of FIG. 2;

FIG. 14 is a VOD display screen for the MIS server of FIG. 2;

FIG. 15 is a live streaming video display screen for the MIS server of FIG. 2;

FIG. 16 is a scheduling setup screen for the MSS server of FIG. 4;

FIG. 17a-b is an embodiment of a flow chart for a CAS server Authentication and Authorization Engine according to FIG. 3;

FIG. 18 is an embodiment of a flow chart for a Dashboard Engine according to FIG. 3;

FIG. 19 is an embodiment of a Manufacturer Registration flow diagram for a Manufacturer Management Engine according to FIG. 3;

FIG. 20 is an embodiment of a Manufacturer Registration flow chart for a Manufacturer Management Engine according to FIG. 3;

FIG. 21 is an embodiment of an Add New Merchant flow chart for a Merchant Management Engine according to FIG. 3;

FIG. 22 is an embodiment of a New Merchant flow chart for a Merchant Management Engine according to FIG. 3;

FIG. 23a-b is an embodiment of a View/Edit flow chart for a Merchant Management Engine according to FIG. 3;

FIG. 24 is a view Merchant Screen for the CAS server according to FIG. 3;

FIG. 25 is an embodiment of a Link/Unlink Manufacturer flow chart for an Administration Engine according to FIG. 3;

FIG. 26a-b is an embodiment of a Camera Setting flow chart for an Administration Engine according to FIG. 3;

FIG. 27 is an embodiment of a VOD Settings flow chart for an Administration Engine according to FIG. 3;

FIGS. 28a-b, 29a-b, 30a-b, 31, 32, and 33a-b are an embodiment of a purchase order request flow chart for a Purchase Order Request Engine according to FIG. 4;

FIG. 34 is a Purchase Order Screen for a Purchase Order Request Engine according to FIG. 4;

FIG. 35 is a Configure Purchase Screen for a Purchase Order Request Engine according to FIG. 4;

FIG. 36 is an embodiment of an appointment flow chart for a Live Streaming Management Engine according to FIG. 2;

FIG. 37 is an appointment request screen for a Live Streaming Management Engine according to FIG. 2;

FIG. 38 is an embodiment of Manufacturer Add/Edit flow chart for a Configuration Management Engine according to FIG. 2;

FIG. 39 is an embodiment of a Special Request flow chart for a VOD Management Engine according to FIG. 2;

FIG. 40a-b is an embodiment of a VOD Storage flow chart for a VOD Management Engine according to FIG. 2; and

FIG. 41 is an embodiment of a Live Streaming flow chart for a Manufacturing Compliance System according to FIGS. 1-4.

### DETAILED DESCRIPTION

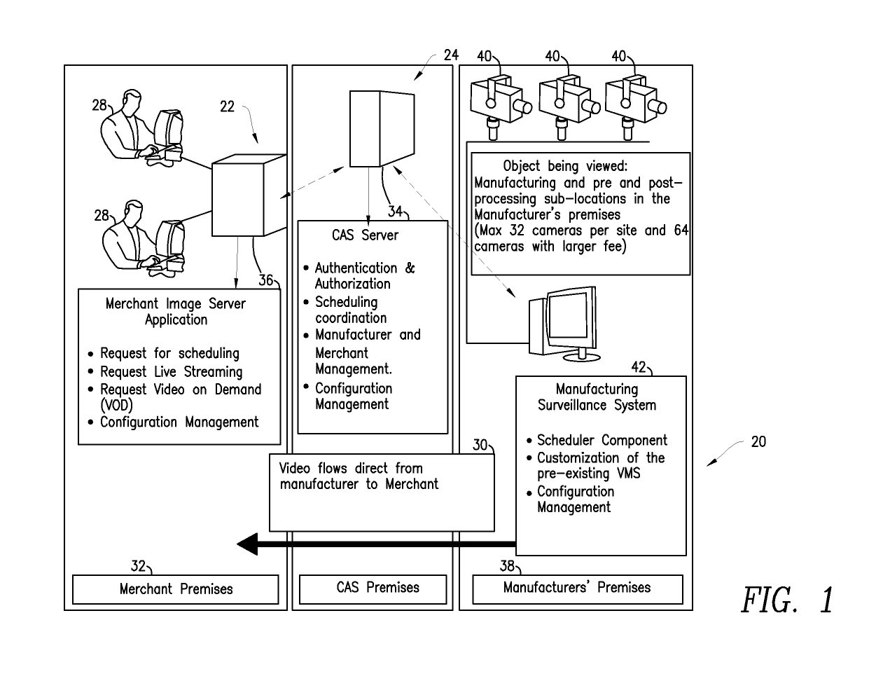

With reference to the Figures for purposes of illustration, a Manufacturing Compliance System (MCS) 20 (FIG. 1) has three major components or sub-systems 1) a Merchant Image System (MIS) 22 located on a server at a merchant facility, 2) a Compliance Assurance System (CAS) 24 located on a server independent of the merchant and manufacturer's facility and, 3) a Manufacturing Surveillance System (MSS) 26 located at the manufacturers facility. Presently the MCS is distributed between the 3 “sub-systems” located at three locations. The term MCS is also referred to as Compliance Assurance Technology (CAT) system as well as Surveillance Compliance System. Although this invention is described in relation to a preferred operating environment, namely, manufacturing, this invention is not intended to be limited to such a preferred environment unless specifically mentioned in the claims.

Advantageously, the Manufacturing Compliance System 20 provides the ability for Merchants 28 to schedule and view live or recorded Video-On-Demand videos 30 of the various stages of manufacturing, packaging, assembly, inspection etc. of their products produced by suppliers, such as, but not limited to, offshore manufacturers and/or third party suppliers. Video compliance can be used for any purpose desired by the Merchant facility 32, such as, but not limited to quality control, acceptable labor practices, i.e. wearing of safety equipment such as goggles, gloves headgear, respirators as well as providing a clean, safe and acceptable work environment and other social compliance requirements. A CAS server 34 that is independent of the merchant and will provide the software component of the system and the scheduling management services controls the MSS. The MIS server 36 will be installed at the Merchant's end, where the Merchant users 28 will be able to request new appointments for viewing the manufacturer's facility 38 using camera 40 connected to a MSS server 42 for purchase orders (PO) to the manufacturer as well as request to see the live stream video from the facility. The merchant 22 will also be able to view video-on-demand recordings already stored at the merchant's premises. It will store all the videos that the Merchant is authorized to view. The CAS server 34 will be the central server managing both of the above components of the system. It will be the central authentication and authorization server between the manufacturers and the merchants. It controls the communication between the MIS and MSS, while the MSS will be installed at the manufacturer end that will be capable of streaming, storing and managing the video for transfer to the MIS server. The CAS server will also be responsible for scheduling the live as well as VOD videos for every PO request from MIS coming via CAS server.

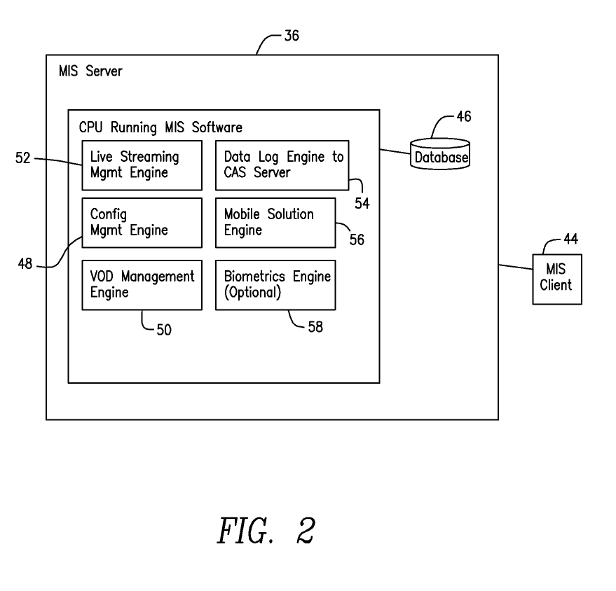

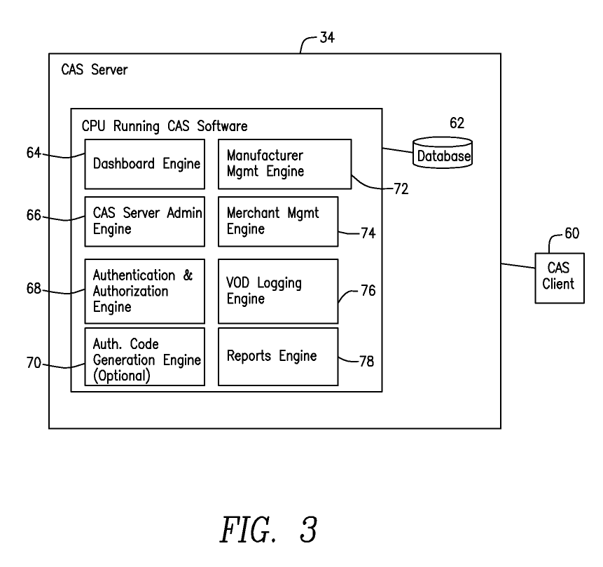

I. Subsystem Roles:
The CAS server 34 (FIG. 3): The CAS server 34 is responsible for administration and user management. It manages the Merchants accounts, Manufacturers accounts, Scheduling of monitoring including exceptional cases from the merchants' request. The CAS server 34 controls the communication between the merchants and manufacturers. The CAS server also controls Camera settings like bit-rate, fps, resolution and the like, but does not interact in the actual transfer of video between the MSS and MIS servers.
The MIS server 36 used by the Merchant User 28 (FIG. 1): The MIS server 36 (FIG. 2) requests new appointments for POs and permits viewing of the live stream as well as the VOD stored on the MIS server 36. The MIS server allows the Merchant 28 to request more video recordings for any PO on exceptional basis. Where an exceptional basis can mean any video recording time frame not normally scheduled by the CAS server, but within the overall time that the manufacturer is working on the merchant's PO. The MIS server 36 supports more than one user 28 for a single merchant and different user access rights. Presently two groups of MIS users are permitted, namely administrator and user. Presently, an MIS Administrator has all the rights of the MIS User, but will be also responsible for user management.
MSS server 42 at the Manufacturer's facility 38 (FIG. 1): The MSS server 42 provides for access by Manufacturer Users. The MIS server 42 can accept or reject the new appointment requests for PO from Merchant and schedule the cameras to be used for the request. The MSS server permits the Manufacturer to reassign or reschedule camera for a PO as well as adjust settings options to match with the camera equipment deployed such as, but limited to, bit-rate, fps, and resolution.

II. Components of the Solution

The term Engine used throughout the specification below means an engine characterized by a self-contained software module running under the control of a computer that performs a set of tasks when called by an application program.

1) Merchant Image System (MIS) Server (FIG. 2):

The MIS server 36 includes two parts having a Server 36 and a Client computer 44. The server 36, running the server application and having a database 46 for storing merchant relevant information and video data, is installed at a networked location from where the client computers running the client application can access it. The client application will be installed on one or more MIS user machines for accessing the MIS Server and provides a user interface to the MIS server.

The following are the sub-component engines of this sub-system:

1. A Configuration Management Engine 48 that includes functions for obtaining User login and User management, New Appointment Requests and Event Tracking. Sub components of the Configuration Management Engine may be understood as follows:
User Management Engine:

a. An Admin user is able to add/update/delete user account. He can also reset the password of any user.

b. Any User can also change his own password.

c. Any User can retrieve their password using password hint/password retrieval functionality.
User Login Engine:

a. Users are authenticated and logged in.
New Appointment Request Engine:

a. A Merchant user can enter the PO/Manufacturer details and request for scheduling of an appointment for viewing the manufacturers' live streaming video. This request can include immediate synchronization with published MSS times of availability at the manufacturer facility or it can be sent to be approved by the MSS user through the CAS.

b. Merchant can view the list of appointments associated with PO date and its acceptance status which are fetched from the database. He can update/delete the pending appointments.
Event Tracking Engine for tracking the List of Cameras and Schedule Information of accepted appointments:

a. User will be able to see the schedule information for a selected PO. Information includes:

i. List of cameras to be viewed.

ii. Camera live streaming: start time/end time.

iii. Manufacturer detail.

2. A Video On Demand Management Engine 50 that includes an engine for requesting exceptional cases, an engine for managing the VOD database storage and an engine for managing display of VOD files as follows:
Request for Exceptional Cases Engine for VOD:

a. User can request for more than 1 hour recording for VOD in exceptional cases to CAS server. CAS admin tracks the requests and logs related details. The manufacturer can accept/reject the request. The notification of the same would be sent to the Merchant and request for more recording would be sent to CAS Server. This request can be for a specific camera or cameras.

b. User can request VOD for specific timings of past.
VOD storage database Engine

a. VOD files will be stored on Microsoft Windows® system.

b. Additional information about VOD will be stored in database:

i. Name, Size, Duration, PO number, Manufacturer name. Manufacturer, location, Camera name. Recording Date, Start Time, End Time.
VOD management Engine:

a. User can use authentication code to view VOD list.

b. The player user interface will be able to play the VOD and will have start/pause/stop/forward/rewind button on video player for VOD.

c. Multiple users can view different VODs at same time.

3. Live streaming management Engine 52:

a. User will be able to see only one live stream at a time. However, more than one user can view the same live stream at a same time. All users will share same Authentication Code generated by CAS server for particular PO number to view the live stream. Presently the default code is the manufacturer name and PO number. Several users from a specific merchant can view a live stream from several different manufacturers at the same time provided MIS has enough bandwidth.

b. The user interface for the video player can vary. In one embodiment, there will be a start/stop button on video player user interface, but live stream data cannot be paused or rewound or fast-forwarded. In a customized player embodiment, the player interface will have start/pause/stop/forward/rewind button on video player for Live stream.

4. Data Log Engine to CAS Server 54:

a. MIS will send different types of data log events to the CAS Server like, but not limited to:

i. User Login/logout

ii. User Live streaming view

iii. User VOD view

iv. Inactive user tries to make new appointment request

v. Inactive user tries to see live steaming request.

Integration Engine with ORMS (Order Request Management System)

a. MIS will be integrated with the third party system so, PO and associated manufacturer information can be fetched while New Viewing Request is made.

5. Mobile Solution Engine 56:

a. Mobile solutions would allow the system to run off-site, bypassing the MIS to view live streams, implementing devices such as the Iphone, RIM devices, and phones and devices running the Android OS.

6. Facial Recognition Engine (Optional) 58:

Facial recognition is a component of the CAS system. As described, MCS defines a predetermined and approved “Appointment”. The MIS facial recognition algorithm will analyze the observed throughout the time period defined by the confirmed appointment. The facial recognition algorithm will evaluate all data collected by cameras. One example of use for this component relates to tracking labors work hours. Should the MIS system detect a laborer has exceeded the maximum allowed number of hours, an “event” or alarm is triggered notifying designated system Administrators.

As an alternative or in addition to facial recognition software component of MIS, a retinal scanning engine can also be used within the MSS.

Another use of these components relate more directly to traditional security and surveillance and the system can be set to trigger alarms or event notifications should the recognition algorithm fail to identify individuals as registered members, employees or guests within a facility.

The facial engine will work with a database having all employee's information including age, video clip, Photo, and age. CAS cameras will be placed at time clock or check in check out stations. Additionally, the engine can work with any CAS cameras placed throughout facilities to identify individuals. When an employee punches or swipes in for work and out from work, the CAS system identifies the employee. Employees are also identified in the factory. The CAS system tracks work hours by day by week and by month. Work-study program allowable hours may also be tracked when underage or students are used. Alarms or notifications can be implemented according to the requirements of the merchant. Exemplary alarm events include, but are not limited to:

i. The number of allowable work hours are exceeded.

ii. A person who is not in the Data base is detected swiping in or out.

iii. A person is detected in the facility who is not in the data base.

iv. An employee is detected in the facility after they have swiped out or clocked out.

v. Work study program allowable hours are also tracked when underage or students are used.

It will be appreciated by those skilled in the art that the facial recognition engine of the present invention is presently contemplated to operate cooperatively existing sensors at the manufacturers facility, namely, the CAS cameras already on site and in a manner that is not noticeable to persons at the Manufacturer facility. However, other biometric devices may be implemented without departing from the present invention, such as but not limited to, finger print scanners and retinal recognition scanners. Furthermore, it will be appreciated that such biometric sensors may be used with other worker compliance scanners such as but not limited to, substance abuse sensors, including breathalyzer sensors.

2) CAS Server 34 (FIG. 3)

There are two parts of this sub-system including a Server 34 and at least one Client computer 60. The server, running the server application and having a database 62 for storing information for merchants and manufacturers, is installed at a networked location from where the client computer(s) running the client application can access it. The client will also be installed at the Administrator's local machine for accessing the CAS Server. This will be the central system having the following functionalities:
Dashboard Engine 64:

a. Following Notification received from MSS will be displayed on Dashboard:

i. Camera Re-Schedule

ii. Camera Re-assignment

iii. Camera name changes

iv. Camera not working
CAS Server administration Engine 66:

a. Admin user will be able to add/update/delete user account. He can also reset the password of any user.

b. User can change his own password.

c. CAS admin can view Live Video streaming independent of schedule

d. He will be able to Activate/Inactivate MIS user

e. He will be able to control camera settings for entire system at one time, or just for an individual factory, or for individual camera. Settings like, bit-rate, fps, resolution etc. can be controlled.

f. CAS admin can also accept/reject request for more hours recording of VOD from MIS. On request confirmation, it will be sent to MSS for rescheduling of VOD recording.

g. User will be able to retrieve the password using password hint/password retrieval functionality.
Authentication and Authorization Engine 68:

a. CAS server will authenticate the merchant users. It will also have the authorization rules which will restrict the Merchant's access to the Manufacturers. The admin will be able to disable any merchant after which the merchant will not be able to login to the CAS Server but can still continue viewing the videos already stored in their local MIS.

b. Validate new appointment request and send information to MSS.

c. Deactivated merchant-user will get the error message every time he does any activity with CAS Server.
Authentication Code Generation Engine (Optional) 70:

a. CAS server will receive new appointment confirmation/rejection notification from MSS.

b. CAS server will generate Authentication code for viewing live stream and VOD based on scheduling information received from MSS on appointment confirmation. This Authentication code will be conveyed to MIS for viewing live stream and VOD.

c. It will also store camera schedule information in CAS database for particular PO number.

In a presently preferred embodiment the authentication code generation engine is not used/included as the authentication code defaults to the manufacturer name and PO number.
Manufacturer Management Engine 72:

a. CAS admin will be able to maintain Manufacturer's information.

b. CAS Server will also have Camera details of every manufacture site.

c. CAS admin can configure MSS server details like MSS server IP, Port etc.

d. CAS server will maintain all manufacturer's user credential for authentication.
Merchant Management Engine 74:

a. CAS admin will be able to maintain merchants information. He will also be able activate/deactivate individual MIS user at any point of time.

b. CAS Server will have all the information for PO and if optionally required will also have mapping to Authentication code for every accepted PO request.

c. CAS admin can configure MIS server details like MIS server IP, Port etc.

d. CAS server will maintain all merchant's user credential for authentication.
VOD Data Logging Engine 76:

a. All the information received from MSS after uploading VOD on FTP will be stored in the CAS server database.
Reports Engine 78:

Following reports are identified for the system. All the reports will be generated on screen and will have the filtering functionality and can be exported to PDF and Excel format.

a. System reliability report by factory, by merchant, and by region.

b. Merchant usage report.

c. Number of “appointments” per Merchant scheduled within a defined time frame and the same for individual associates.

d. Showing individual tends to use VOD and rarely views streaming or if streaming is the focus of interest.

e. Factories that most often complete “appointments” successfully and on time, based on number of occurrences, or inverse to that, a list of factories that most often have problems.

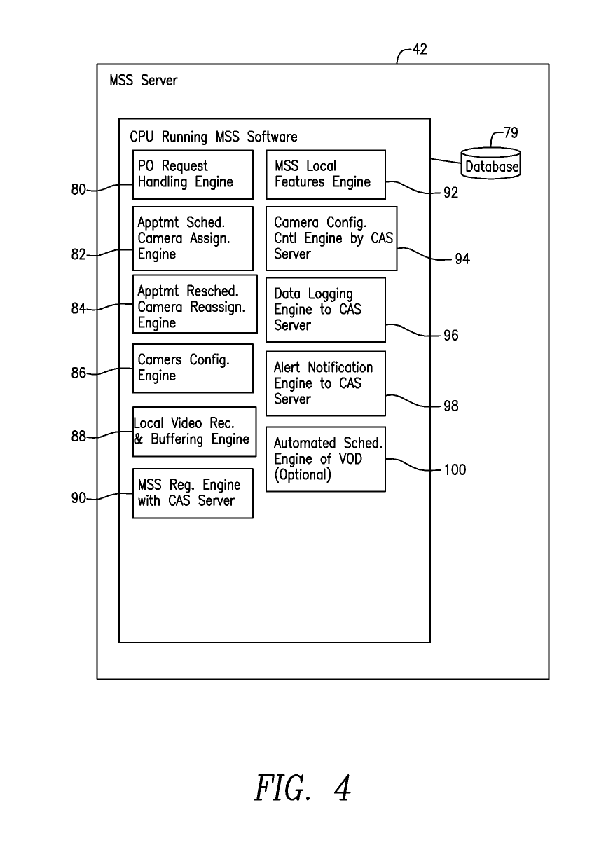

3) Manufacture Surveillance System (MSS) Server 42 (FIG. 4):

This component will be installed at the manufacturer's end. Following are the functionalities of this component:
PO Request Handling Engine 80:

a. MSS will be able to handle PO request from CAS server and will notify to CAS Server.
Appointment scheduling/Camera assignment Engine 82:

a. MSS Admin will be able to assign and schedule cameras based on PO. MSS will send schedule information to CAS server.
Appointment rescheduling/Camera reassignment Engine 84:

a. MSS Admin will be able to re-assign and reschedule cameras. This information will be provided to CAS server. Scheduler should be overridden in exceptional case.
Camera configuration Engine 86:

a. MSS will be able to set individual camera configuration at initialization as per user manual.
Local Video Recording and Buffering Engine 88:

a. MSS is capable to record 24×7 for all cameras locally. Manufacturer can set working times of factory. Recording will happen only for the working hours. If the cameras are not set to stream, it will not be able to relay the live stream or record the video for that specific time.
MSS Registration Engine with CAS server 90:

a. MSS should be able to register with CAS server
MSS Local Features Engine 92:

a. MSS will have features like streaming the live as video, play recorded video, configuration of cameras, PTZ control, IP configuration.

b. MSS will have VOD playback features like pause, rewind, fast-forward, file seek, next frame, previous frame. These features would optionally be available for live video stream.
Camera Configuration Control Engine by CAS server 94:

a. CAS server should be able to set camera settings.
Data Logging Engine to CAS Server 96:

MSS will send different types of foot prints to CAS Server like:

a. Camera name change

b. Camera not working (Network disconnected or power out)

c. Upload started

d. Upload complete

e. Start of Live streaming

f. Schedule start/stop events

g. Network related system failure

h. Software related system failure

i. MSS outage

j. Internet connectivity failure

k. Bandwidth calculation

l. Hardware related system failure (DVR not working, cameras not working, internet down)

m. Camera blocked by physical object

n. Attempt to change date and time. If time stamp is altered we should be alerted.

o. System diagnostics

p. Electrical outages
Alert/Notification Engine to CAS Server 98:

a. Camera add, delete & edit events

b. Camera name change

c. Camera not working (Network disconnected or power out)

d. Rescheduling/reassigning of camera

e. Attempt to change date and time.

f. Camera blocked by physical object
Platform Support:

a. MSS Graphical User Interface (GUI)

i. MSS GUI will be supported in Microsoft Windows XP® platform

b. Local Storage

i. 24×7 recorded video can be stored in Microsoft Windows XP®, Microsoft Windows 7® or Linux operating systems. It will be appreciated by those skilled in the art that such systems are not listed to be limiting, but are merely representative and other operating systems may be employed without departing from the invention.

The MSS server cooperates with the cameras and other data gathering components on site in which the following configurations are relevant:
Camera features:

a. Max Camera number supported.

i. 32 cameras will be supported at MSS side, but it is presently preferred that a maximum of 16 cameras will be available at any point of time for each MIS associated with the MSS. MSS can support up to 64 cameras where such extra camera access can be purchased by a merchant. It should be noted that the quantity of cameras described herein are exemplary of the preferred embodiment, but should not be considered limiting to the present invention.

b. Compression efficiency

i. MSS will record with the same degree of compression while maintaining acceptable image quality.

c. Supported cameras with MSS that are suitable for this purpose include conventional surveillance cameras capable of digital feed where additional cameras can be added to accommodate new configurations.
VOD features:

a. VOD Recording

During scheduled assignment for each camera, MSS will record 1 hour/camera/day of VOD based on random scheduling. Scheduling algorithm will run MSS. However, CAS will be able to override VOD schedule for single camera, individual factory and all factories at the same time.

b. VOD via FTP

MSS will upload VOD files to MIS via FTP. VOD files will be 1 hour/camera/day. On exceptional cases the VOD will be recorded for more or less hours.

c. VOD information

Following information about VOD will be provided by MSS to CAS server: Name, Size, Duration, PO number, Manufacturer name. Camera name. Recording Date, Start Time, End Time, transfer speed. Transfer speed will be calculated from following equation at the end of FTP transfer:

ii. Speed=No. of bytes transferred/time to transfer.

d. Secure File format for VOD-TDB
Live video stream features:

a. Viewing Live Stream

i. MSS will provide live stream directly to MIS for requested duration within scheduled time. MSS will stream only one live stream per MSS at any given time. Video data will not be routed through CAS server. MSS can stream at least one live stream per MSS at any given time. MSS can stream more than one stream if enough bandwidth is available.

ii. MSS will allow switching between camera stream when requested by merchant-user i.e. stop current stream and switch to new stream.

b. Live Stream control by CAS

i. MSS should be able to stop or switch camera when requested by CAS.

c. Bandwidth utilization for live streaming

i. Automatic scaling to adjust with available bandwidth
Offloading MSS GUI on video cards:

a. In one preferred embodiment, to reduce System CPU processing, MSS GUI can be offloaded on video graphics cards.

In an alternate embodiment, VOD scheduling is automated through the use of RFID tags.
Automated Scheduling Engine of VOD (Optional) 100

a. The system as defined above requires the manual entry of a schedule which then automatically sets the start and stop times for each camera. Automated scheduling eliminates this requirement.

The process is the same as is described above but when the observed confirms an appointment (i.e. grants permission to view), a series of RFID tags (Radio-frequency identification tags) are associated with the appointment request and specific purchase order, production run, or production cycle named in the appointment request.

In other words, as an alternative to the manual entry of scheduling information that ties specific cameras in specified areas of a manufacturing facility, to specific production runs, this manual entry process can be automated using RFID tags (Radio-frequency identification tags). In any section of a factory or stage of a production run, local area transmissions from RFIDs are set to trigger cameras on and off These tags are identified and linked to specific purchase order requests, products, or productions runs. The RFIDs are associated with production runs automatically, when “appointment requests” are accepted. They are reassigned as needed, either automatically or manually “linked” with a production run, order, or product. One RFID signal, at the start of a production run, would signal the relevant cameras in the area or along a pre-defined line—to begin recording. The captured video, triggered by the RFID tied to a specific order, would be filed according to the trigger. Cameras are turned off, the recording stopped, or file associations changed, when instructed to do so by a second or subsequent RFID signal received from a second or subsequent RFID tag.

As an alternative to RFID tags, bar codes can also be used. Cameras, using video analytics are able to identify specific bar codes set up along a production run to identify purchase orders associated with those bar codes. Bar codes instruct the system how the video is to be stored with file names identifying the required detail.

In a classroom or school environment that has the MCS system installed, the use of either the RFID component or the facial recognition engine could eliminate or minimize the need for school administrators to manual enter a student's scheduling information. School administrators would only need to approve parent's rights to use the system. The administrator would assure a parent's authorization is associated with the correct student. The student would be provided with an RFID medallion or bracelet that cameras or RFID receivers automatically detect, starting and stopping recording based on the presence of the student.

Note that RFID tags could trigger specific cameras to start or stop or could provide the MCS system with software notification of “events” used to properly file or label recorded or streaming video (data). Direct notification of the MCS system would negate the need for the RFIDs or RFID receivers to interact with the cameras. Information such as a purchase order number, product number, or student identification numbers transmitted by RFID and collected by RFID receivers can be correlated with the video (data) collected by cameras at specific times and from specific locations, tagging the files or streaming media accordingly. In effect, this is a process of asset tracking using RFID. What makes this a process unique to MCS is that permissions must be granted to the client that wishes to view the observed and these permissions are based on a schedule accepted by or created by the observed.

An alternative to RFID tags, signals from Cellular phones or GPS data from cell phones could also trigger the creation of tags or events to be correlated with the video (data) collected by cameras at specific times and from specific locations, tagging the files or streaming media accordingly based on the location of the phone.

MCS Configuration Assumptions

It should be understood that under the current configuration, no video is routed through the CAS Server. For Live stream the video would directly be streamed from MSS to MIS. For VOD, the MSS will FTP the VOD to the MIS server directly. Before doing any activity the CAS need to authenticate whether the Merchant is active or not. A video player for streaming video on the MIS Client of the type suitable for this purpose is a cross-platform open-source multimedia player. The actual video uploading will be done by MSS using FTP or other data transfer means. If more than one merchant is assigned to one manufacturer at different time slots, one hour of VOD per day would be of anyone merchant per day. If there are two merchants, there will be two hours per camera. For available bandwidth of 256 kbps at MSS, for camera configuration of VGA @ 7 fps @ 256 kbps bit-rate, only one live stream per MSS will be available for viewing. If more than one merchant is assigned to one manufacturer for separate cameras at same time slots, only one live stream will be streamed out of MSS i.e. only one merchant will be able to view live stream due to bandwidth constraints at MSS. Multiple streams can be streamed for each merchant if there is enough bandwidth available. If resolution or FPS of live video is changed based on bandwidth, VOD going on at the same time will be affected. MSS users/group will be administered separately from CAS admin and their rights will be decided by MSS admin. Whenever a new user is added in MIS by MIS admin user, it will also be added into CAS server as a Merchant's associate user. CAS admin can only activate/deactivate merchant's associate user but cannot edit any information. CAS admin can activate/deactivate merchant or associate. CAS will be able to change Video resolution, frame-rate, bit-rate and audio parameters of camera. Compression efficiency for VOD and local storage of videos will depend on individual cameras and its configuration. Authentication would be required for viewing VOD only if the Merchant is active on CAS. The Scheduler and the algorithm would be part of MSS and on exceptional basis (for e.g. changing the recording hours or getting the recorded videos for specific hours) can be controlled by the CAS. CAS can override VOD scheduling for single camera, individual factory, or all factories at same time on an exceptional basis. VOD upload time will be dependent on available bandwidth and compression capability of camera.

### Embodiment I of the MCS Server Engines

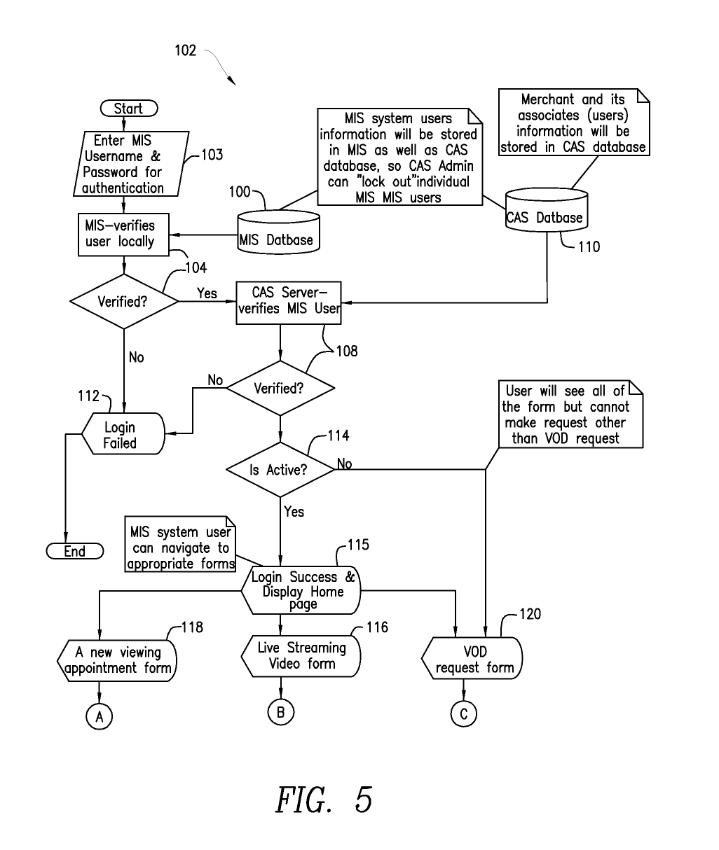

MCS provides a means to allow viewing of video, either live or recorded, based on pre-arranged and confirmed viewing times. An embodiment of the MIS Server, CAS Server and MSS Server exemplary engines interactions is illustrated by the flow diagrams of FIGS. 5-8.

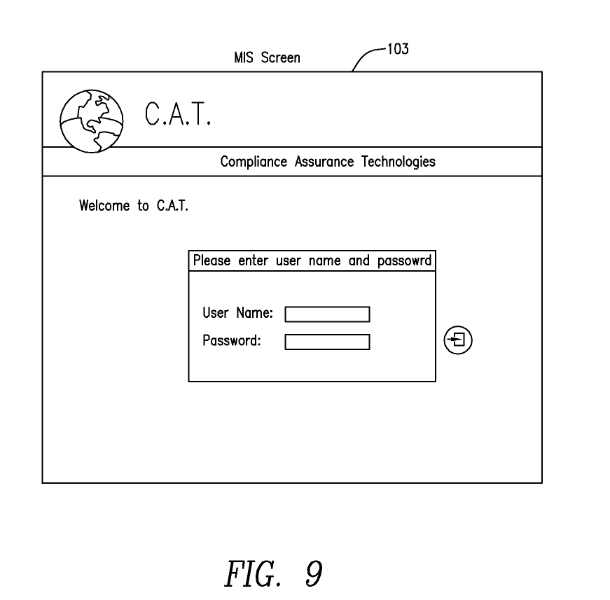

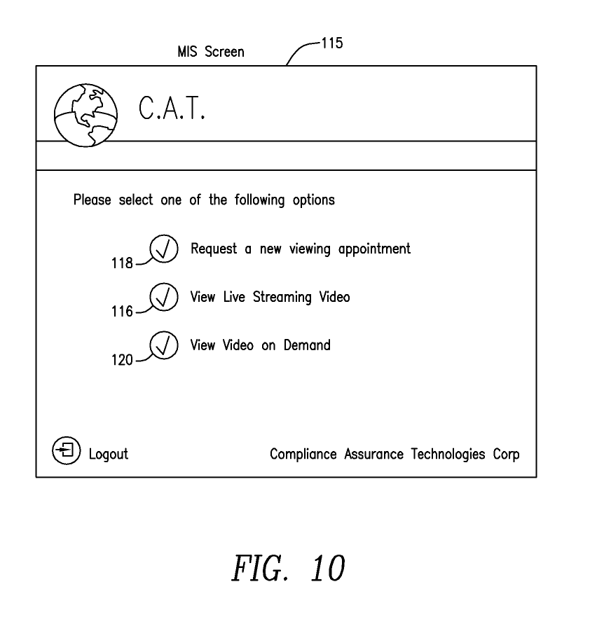

With reference to FIG. 5, a login sequence 102 for an MIS user 28 includes a local verification step 104 with the MIS database 106 from a login screen 103 having user name and password fields with a submit button (FIG. 9) and a remote verification step 108 (FIG. 5) with the CAS database 110. If either verification fails, a login failed step 112 is run; otherwise the user is checked as an active or inactive user at step 114. Active users may access functionality through a selection screen 115 (FIG. 10) for live video at step 116 (FIG. 5) and schedule new recordings at step 118 as well as view VOD at 120. In active MIS users may only view existing VOD files at step 120.

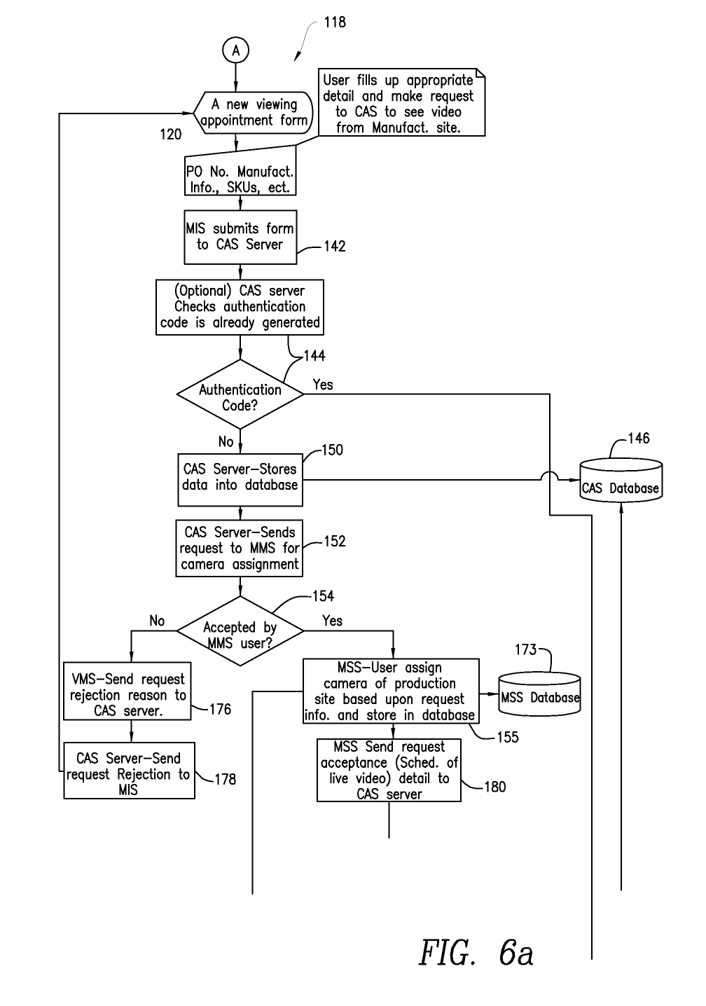

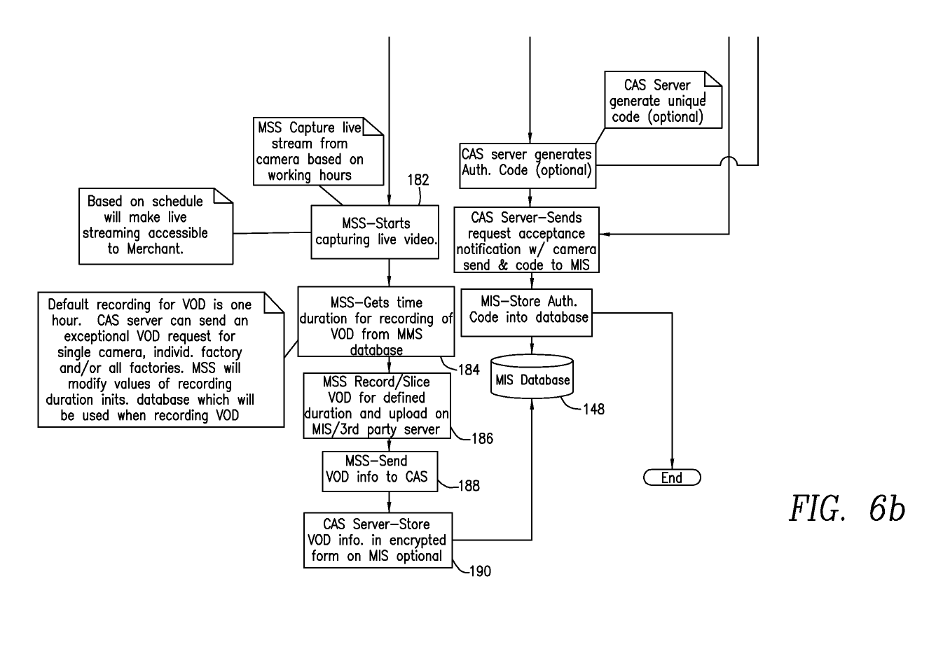

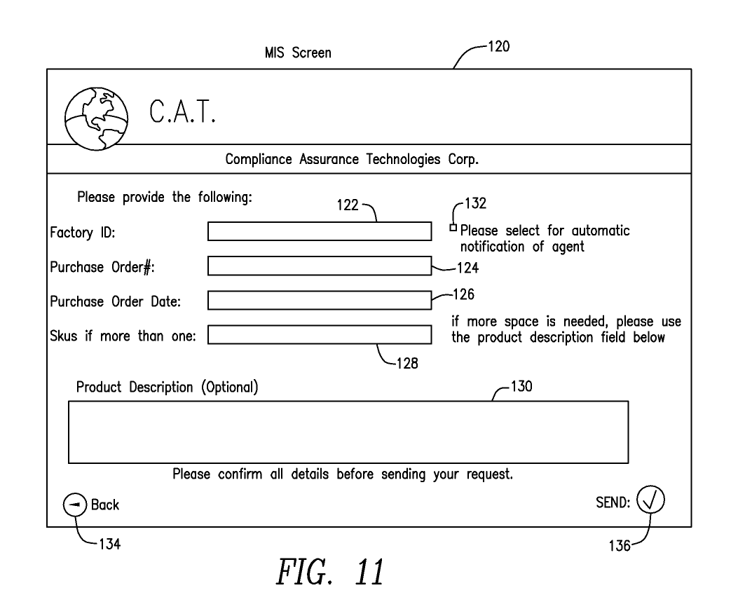

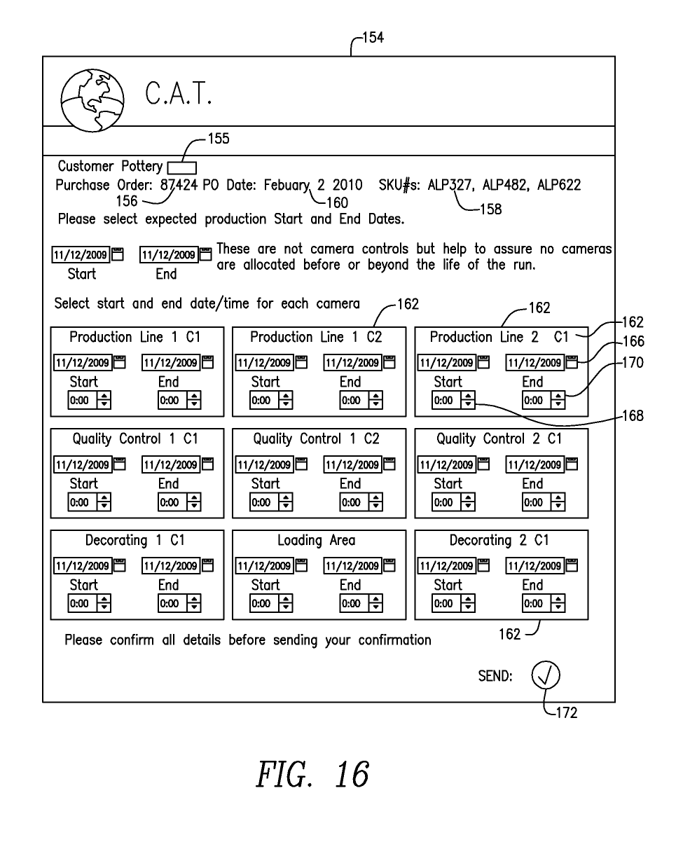

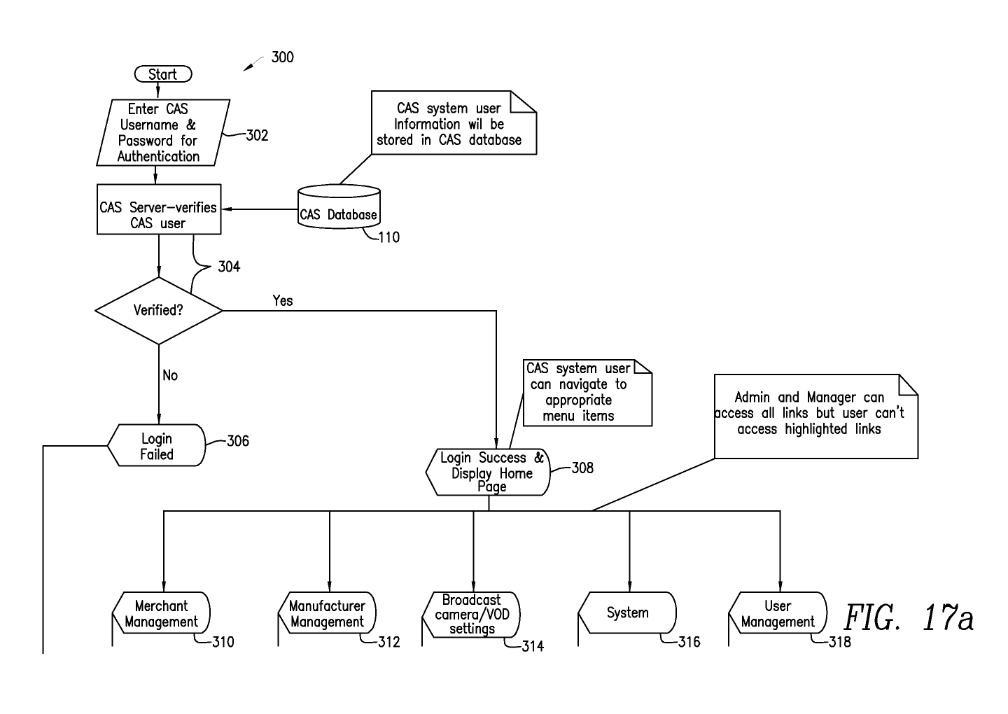

With reference to FIGS. 6a-b, the new viewing appointment sequence 118 provides access to a request screen 120 (FIG. 11) that includes fields for the factory ID 122, Purchase Order No. 124, Purchase Order Date 126, PO related SKUs 128 as well as product description 130 and a auto notify button 132. Upon filing in the request form, the user can go use a back button 134 to cancel the request or use a send button 136 to make the request. With reference again to FIGS. 6a-b, the appoint request data is submitted to the CAS server at step 142. An optional authentication code sequence begins at step 144 otherwise, the purchase order number is used as the authentication code, either of which is stored both in the CAS database 146 and MIS database 148. The appointment data is then stored in the CAS database 146 at step 150. The CAS server requests the MSS server confirm the appointments at step 152. If the MSS user will confirm then an MSS confirm screen 154 (FIG. 16) that shows the Merchant name 154 and purchase order information including the PO number 156, products 158 and run dates 160. Cameras 162 within the field of view of the work being done for the purchase order are displayed showing location 164, dates available 166 and start 168 and end 170 times. Upon configuring the video appointment, a submit button 172 is provided. If not accepted at step 154, a rejection reason is given to the CAS and MIS at steps 176 and 178, respectively. If accepted, the MSS server sends an acceptance at step 180. Then video storage is started at step 182 and the duration and recording is made at steps 184 and 186 where the video is sent directly to the MIS server database. Related data for the recording is sent to the CAS server at step 188 and the CAS server confirms the VOD info is optionally stored with the video in an encrypted form at the MIS facility at step 190.

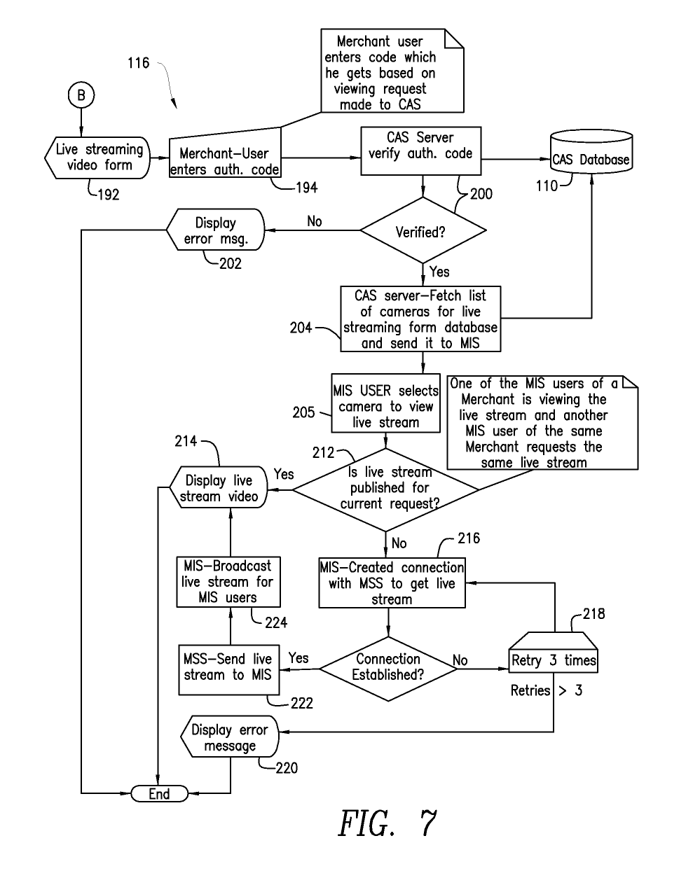

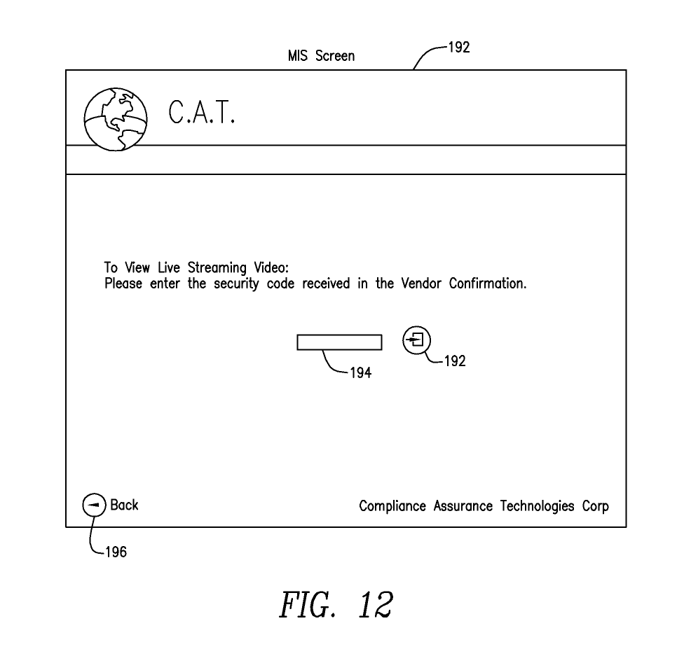

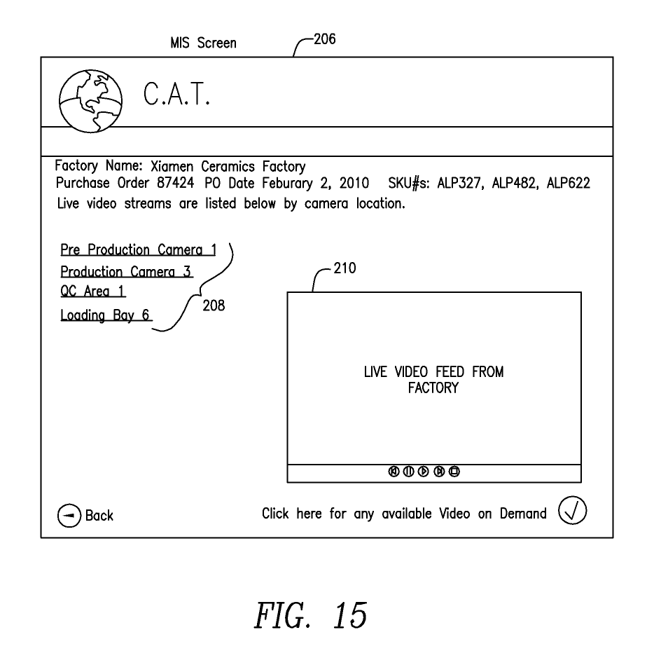

With reference to FIG. 7, a live video sequence 116 includes an authorization code screen 192 (FIG. 12) having an authentication code field 194 as well as a back button 196 to cancel the request and a send button 198 to make a request. The request for live streaming is verified with the CAS Database 110 at step 200. If not, an error message is generated at step 202; otherwise, a list of cameras for view is made available at step 204 on a screen 206 (FIG. 15) having links for cameras 208 and a video display window 210. If already in use by another MIS user at step 212 (FIG. 7), then the user is added to the existing feed at step 214. Otherwise, a request is made for live feed to the MSS server at step 216. If not, three retries are made at step 218 before and error message is generated at step 220. Otherwise, the MSS server begins streaming live data to the MIS server at step 222 and the video is displayed at step 224.

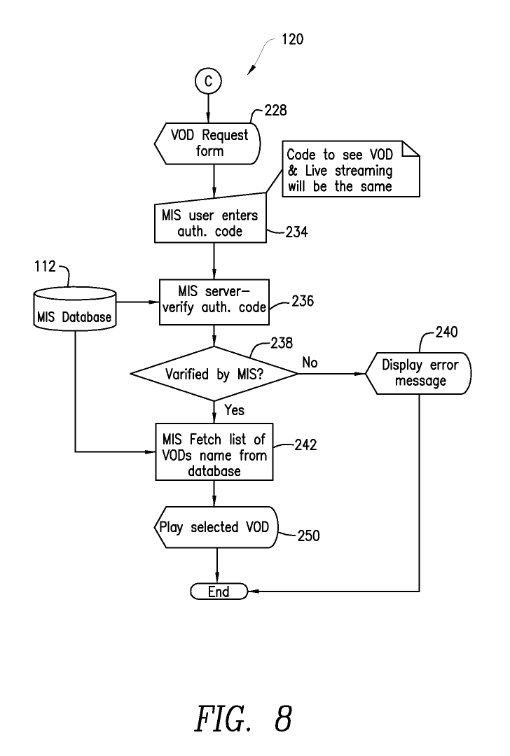

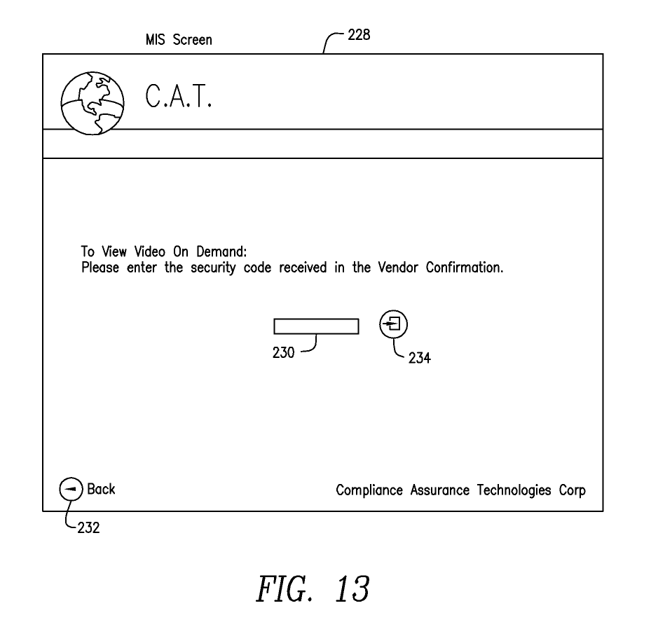

With reference to FIG. 8, a VOD sequence 120 includes an authorization code screen 228 (FIG. 13) having an authentication code field 230 as well as a back button 232 to cancel the request and a send button 234 to make a request. The request for live streaming is verified with the MIS Database 112 at step 236 and checked at step 238. If not, an error message is generated at step 240; otherwise, a list of VOD files and dates for viewing is made available at step 242 on a screen 244 (FIG. 15) having links for VOD files 246 and a video display window 248. The VOD file is then displayed at step 250.

### Embodiment II of the MCS Server Engines

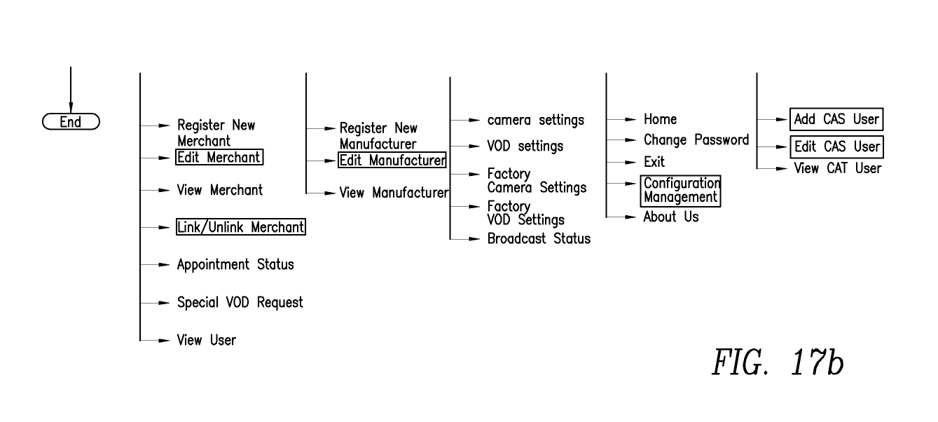

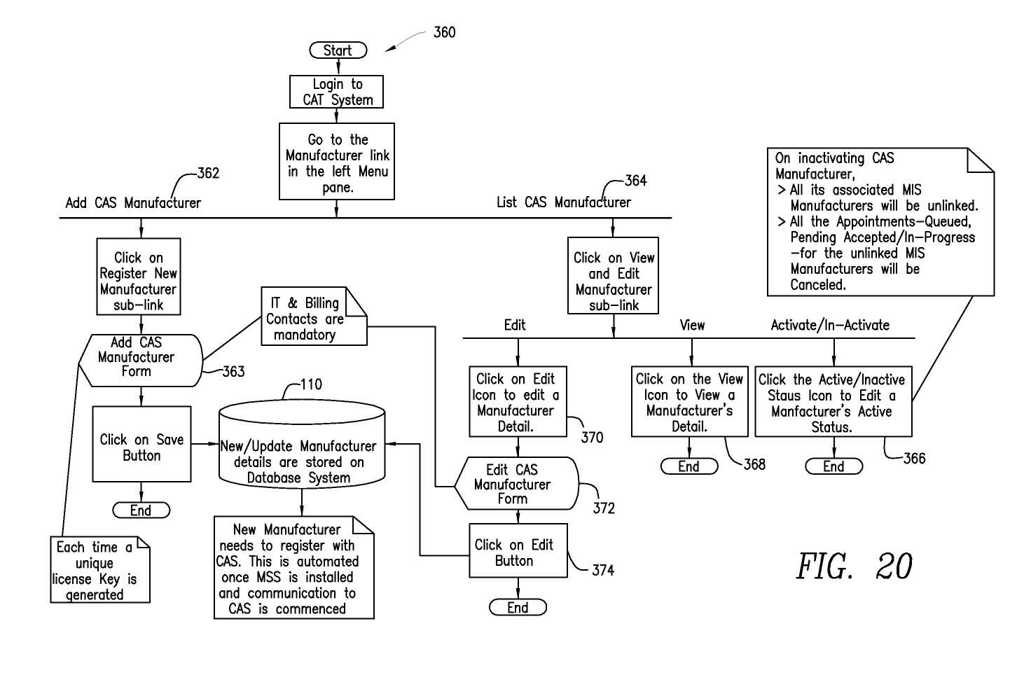

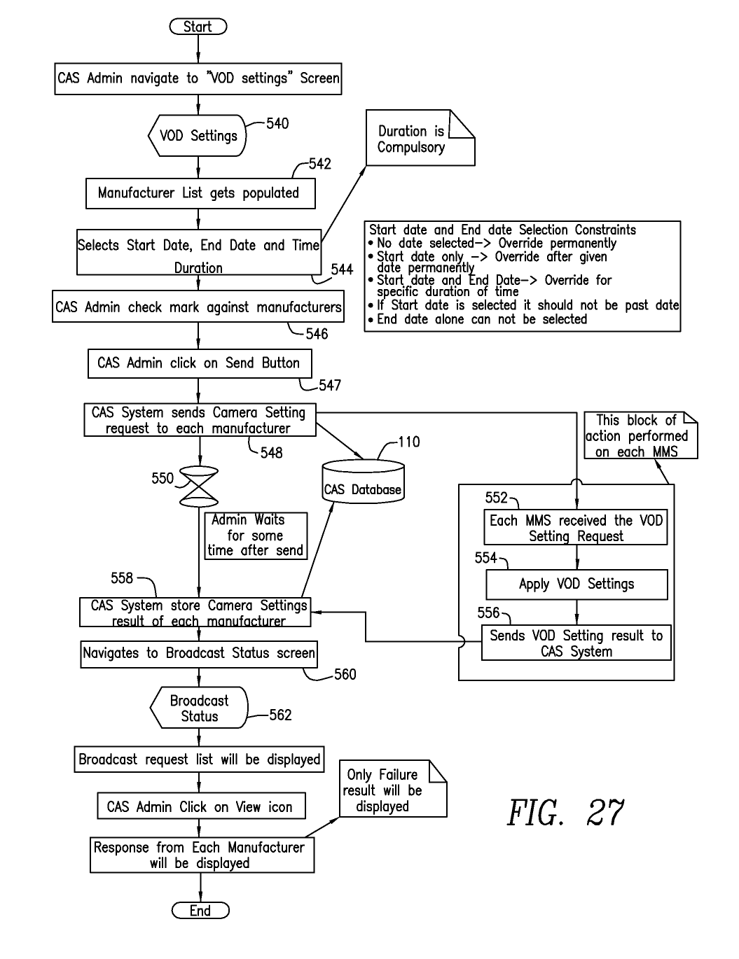

MCS provides a means to allow viewing of video, either live or recorded, based on pre-arranged and confirmed viewing times. Another embodiment of the MIS Server, CAS Server and MSS Server exemplary engines interactions is illustrated by the flow diagrams of FIGS. 17-41.

With reference to the CAS server 34 of FIG. 3, FIGS. 17-27 illustrate the presently preferred flow diagrams for the CAS server engines.

With reference to FIG. 17a-b, a log-in sequence 300 for the CAS server is illustrated where a user enters a username and password at step 302 and the username and password is verified with the CAS Database 110 at step 304. Failure to login results in an error message at step 306; otherwise, the user is directed to a home page at step 308 where access to the merchant management engine 310, manufacturer management engine 312, Broadcast Camera/VOD setting Engine 314, System engine 316 and User management Engine 318 is accessed.

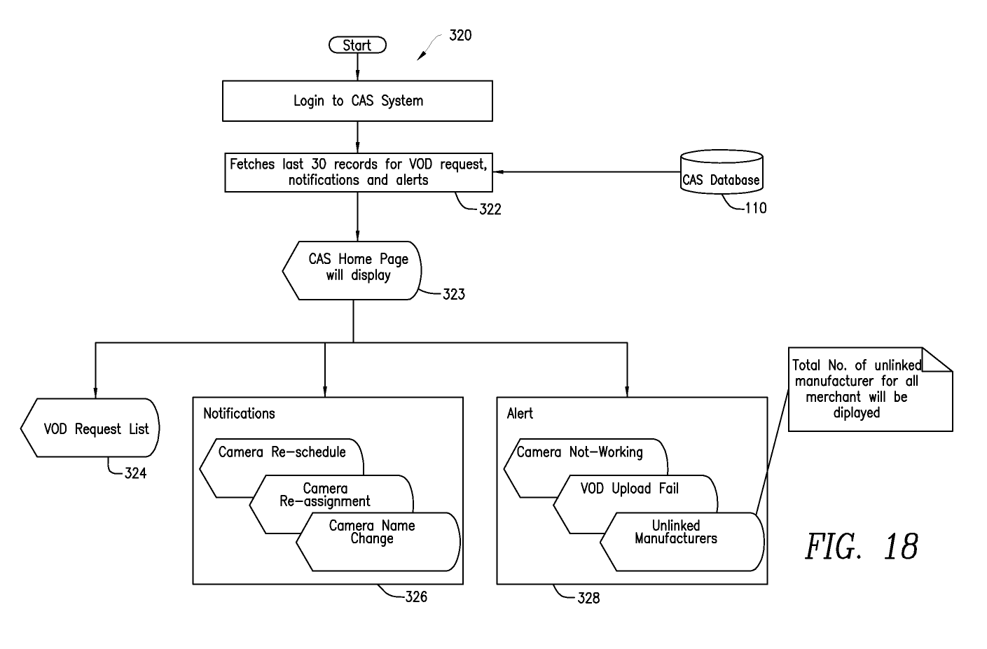

While displaying the home page, a Dashboard engine 320 (FIG. 18) is running in the background with a time delayed refresh capability that displays the last 30 records of VOD requests at step 322 from the CAS database 110. The information includes, but is not limited to, the request list 324, Notifications 326 including camera changes, MIS and MSS server data changes and Alerts 328 such as camera malfunctions, data links down causing transfer failures and unlinked manufactures from MIS records.

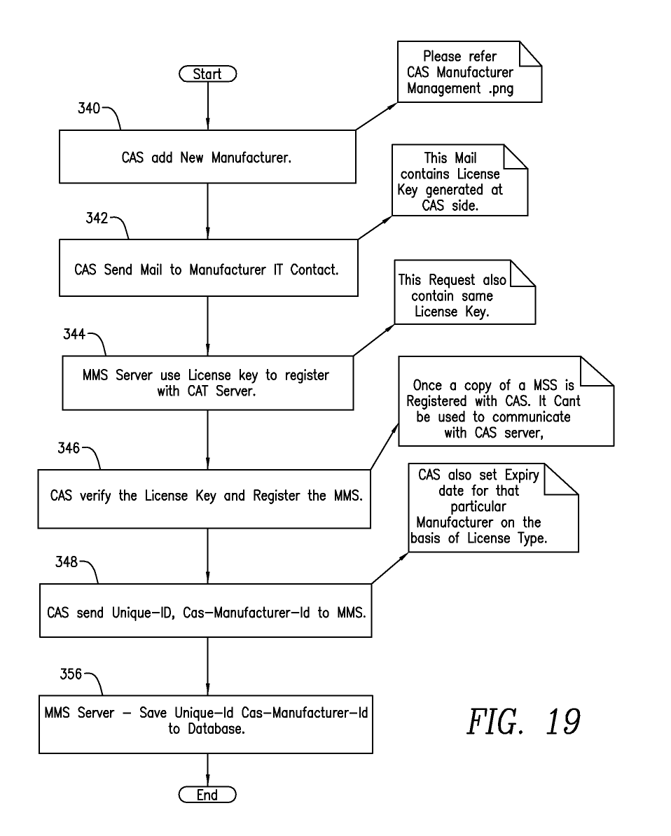

With reference to FIG. 19, the CAS server, when running the manufacturer maintenance engine for adding a new manufacturer, has user interface interactions that include selecting at a new manufacturer 340, sending a license key email to the MSS user 342, MSS user enters the license key into the MSS server 344, The CAS verifies the license key and registers the MSS server 346. The MSS receives a unique manufacturer ID 348 that is saved into the MSS database 350.

Given these interactions, the Manufacturer Management Engine 360 includes a select add manufacturer 362 or list manufacturer 364 link.

When the add manufacturer link 362 is selected an add manufacturer form is presented where appropriate information about the manufacturers facility, number of cameras, other data recording devices and contact information is entered. Entering the information and hitting save result in storage of the manufacturer information in the CAS database 110 and transmission of a license key to the MSS server. Once the MSS user registers the manufacturer will then be add to the active list of manufacturers.

When the list manufacturers link 364 is selected the CAS user can activate/deactivate a manufacturer at step 366, view the manufacturer record at step 368 or edit the manufacturer information at step 370 where an update form is used to update the manufacturer information at step 372 and save button 374 is selected to save it.

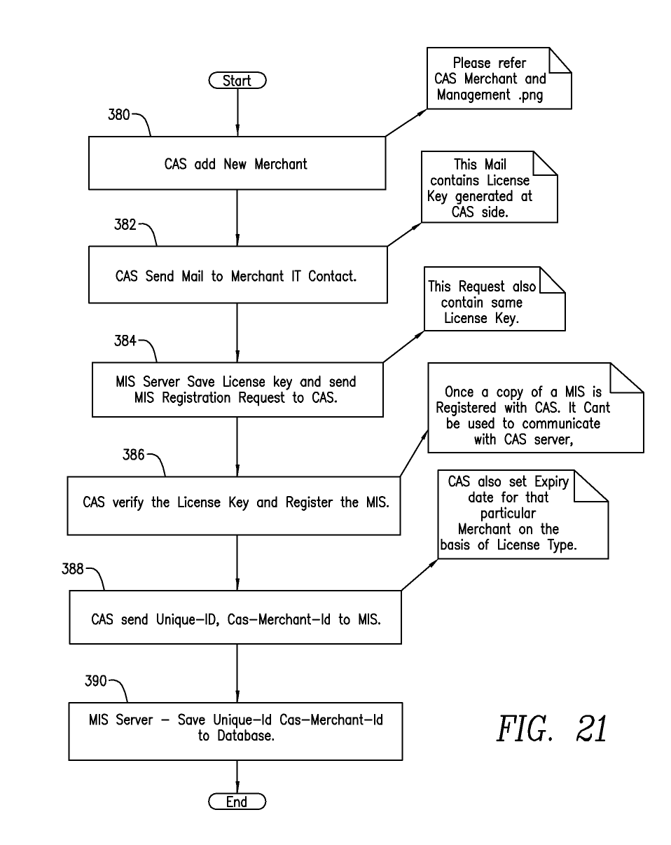

With reference to FIG. 21, the CAS server, when running the merchant maintenance engine for adding a new merchant, has user interface interactions that include selecting at a new merchant 380, sending a license key email to the MIS user 382, MIS user enters the license key into the MSS server 384, The CAS verifies the license key and registers the MIS server 386. The MIS receives a unique merchant ID 388 that is saved into the MIS database 390.

Given these interactions, the Merchant Management Engine 400 includes a select add manufacturer link 402.

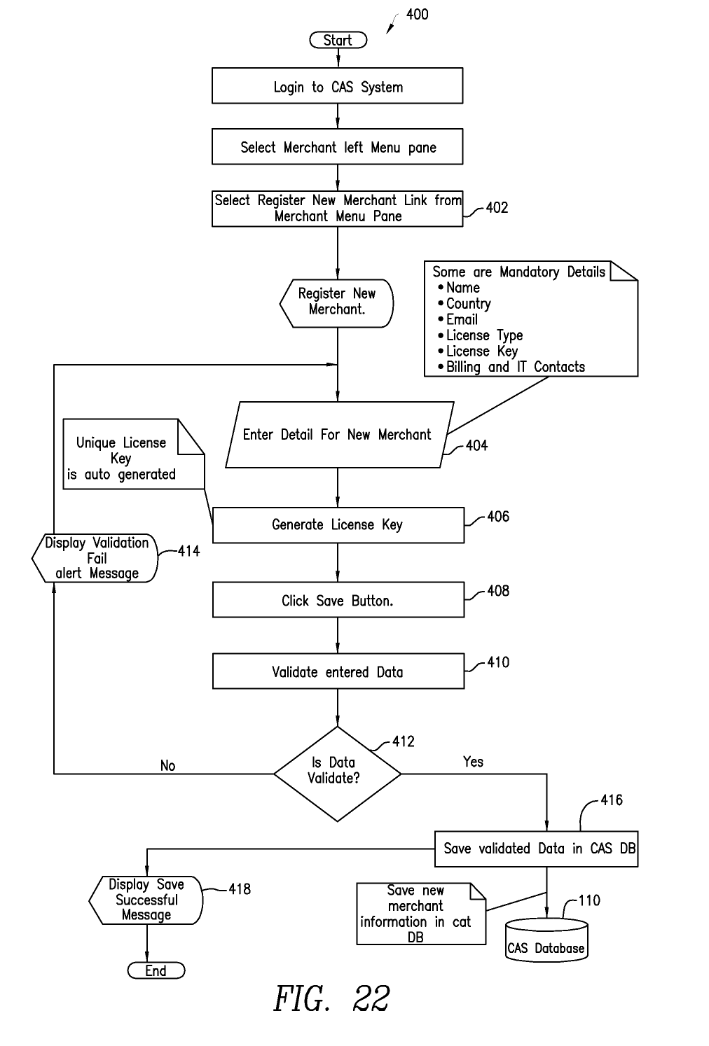

With reference to FIG. 22, the add merchant sequence 404 includes selecting the add merchant link 402, adding the merchant information at step 404, generating a license key at step 406, saving the information at step 408. A data validation check is made at step 410 and 412. If invalid an error message is generated at step 414 and the user is asked to re-enter some data. Otherwise, the new merchant information is saved at step 416 into the CAS database 110. A save successful message is displayed at step 418.

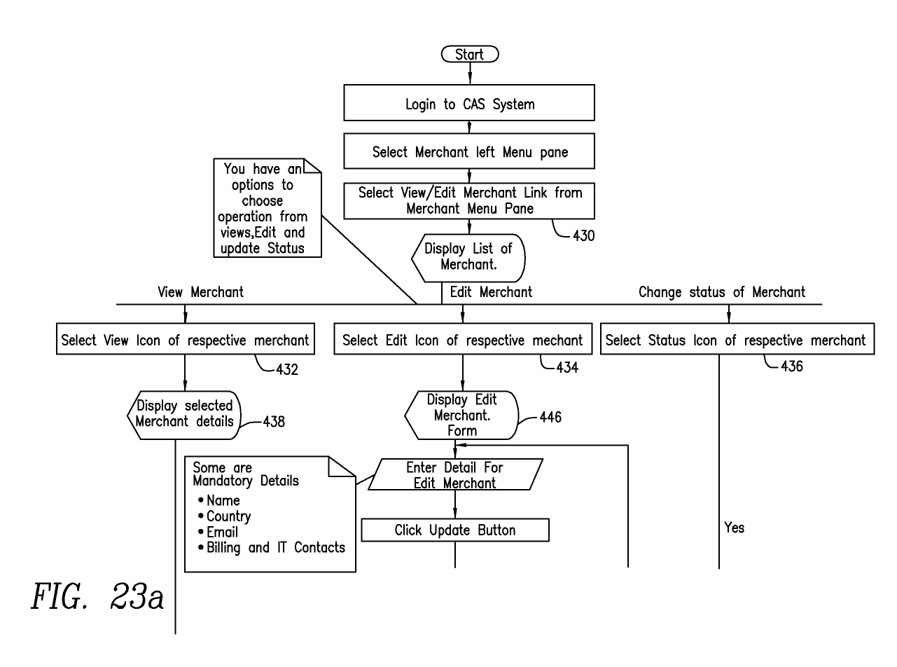

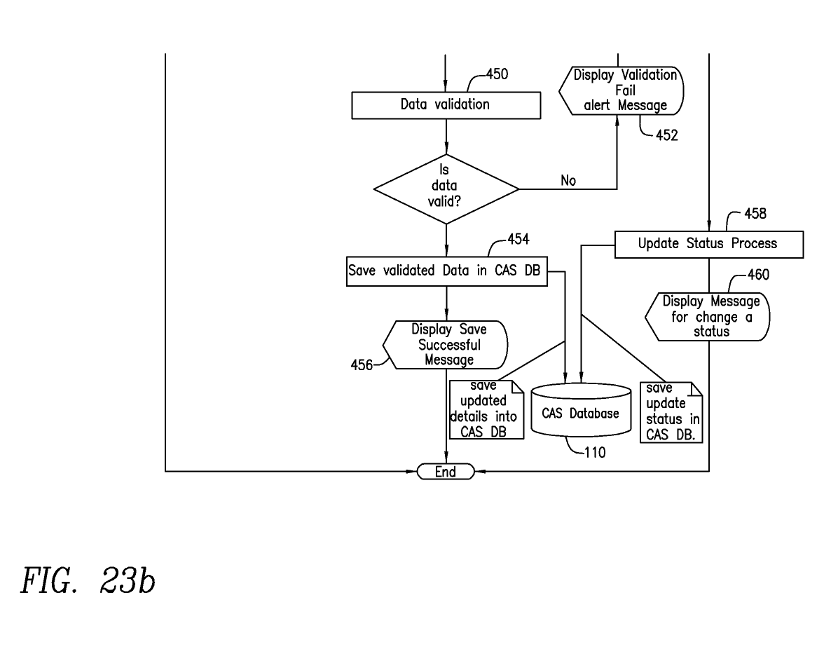

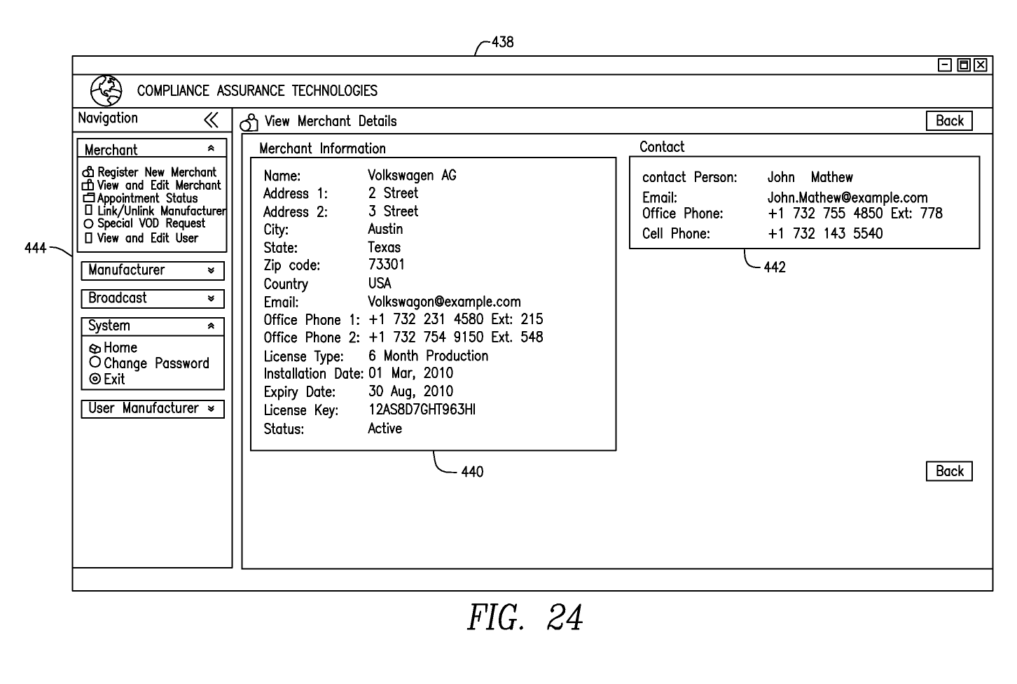

When it becomes necessary to view or edit a merchant record, the display merchant list link is selected at step 430 (FIG. 23a-b). Options then include viewing a merchant at step 432, editing a merchant at step 434 and changing the status of a merchant at step 436. When the view merchant information at step 432 is selected, the server generates a screen 438 (FIG. 24) showing the merchant information 440 and contact information 442. In the presently preferred embodiment, a collapsible menu 444 is available to simplify navigation through the merchant management engine screens.

When the edit merchant step 434 is selected (FIG. 23a-b), the merchant form is displayed again at step 446 with the existing merchant information allowing the user to change information relevant. When the changes have been made a update button is selected at step 448. The merchant data is again validated and checked for errors at step 450. If there is an error an error message is generated at step 452 other the merchant updates are saved to the CAS database 110 at step 454 and a successful save message is displayed at step 456.

When the change status step 436 is selected, the status of the merchant is displayed at step 438 as either active or inactive. An update status step at 458 is selected and the updated status is stored in the database and a success message is displayed at step 460.

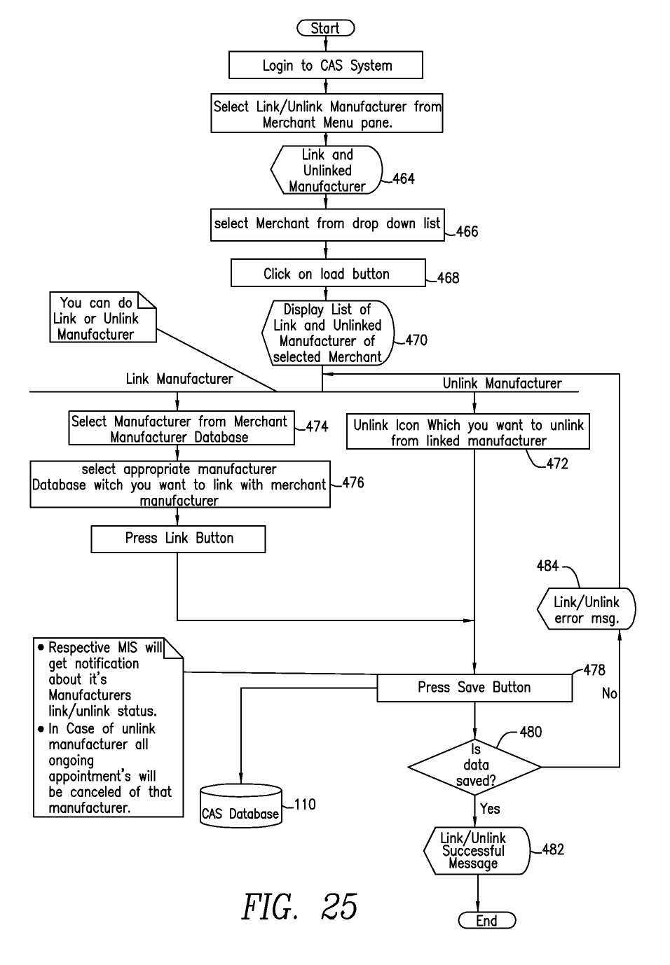

The CAS server controls communication the MIS servers and MSS servers. These servers can be linked or unlinked by the CAS. The link/unlink sequence 464 (FIG. 25) includes a list merchants and select merchant at step 466. The merchant record is loaded at step 468 and the merchant information is displayed with available manufacturers at step 470. A link to unlink at step 472 and to link at step 474 is selected. If link is selected, a manufacturer is chosen from a list of available manufacturers at step 476 and a link record is set. The record is then saved to the CAS database 110 at step 478. A check is made at step 480 if the saved record is successful a success message at step 482; otherwise, an error message is generated at step 484 and the user is returned to the link/unlink selection screen at step 470.

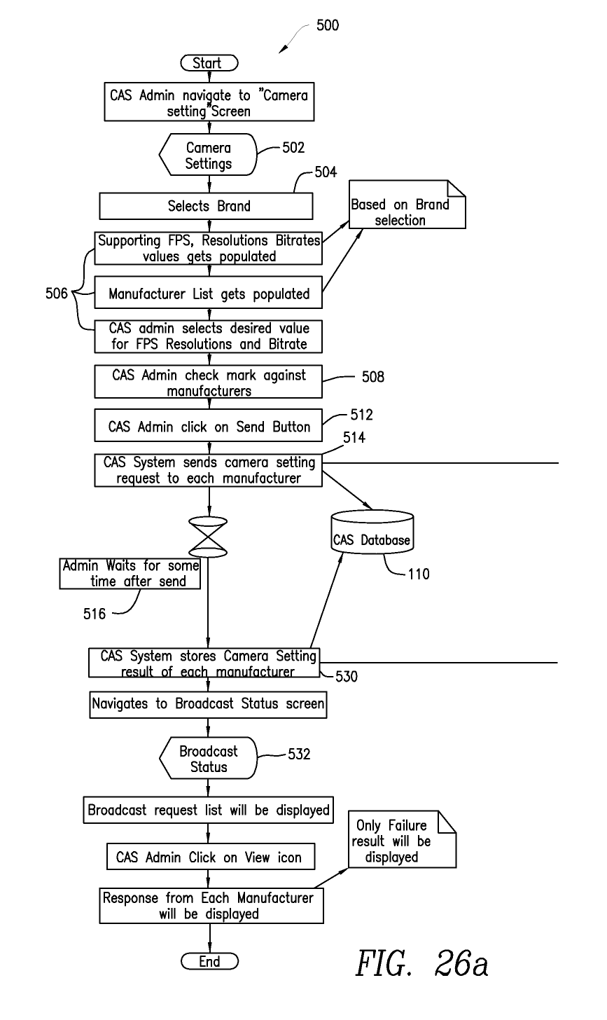

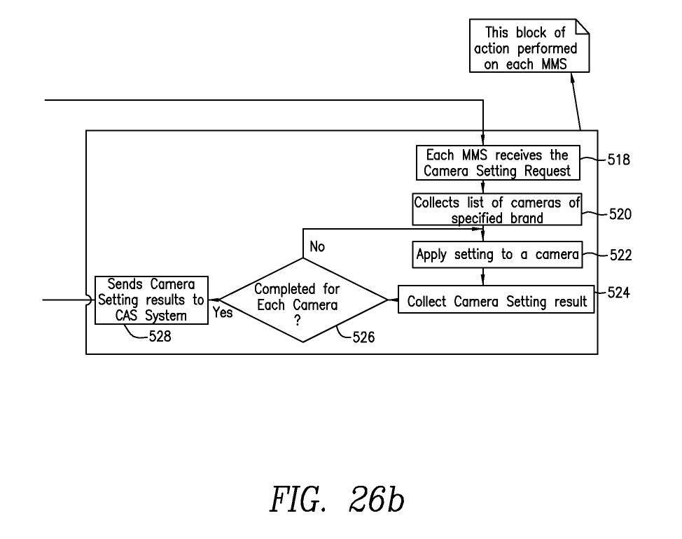

The CAS also controls the settings of the cameras at each of the MSS facilities. A camera settings sequence 500 (FIG. 26a-b) includes selecting camera settings at step 502. Selecting a camera type at step 504. Adjusting supported data values such as, but not limited to, bit rate, FPS and resolution values. Then MSS servers that connect to these types of cameras are displayed at step 506. The values for the cameras are then updated for each MSS or globally for the chosen camera type at step 508. Manufactures selected and having these cameras are tagged for uploading at step 510. A command to update the MSS servers selected is sent at step 512. The new settings are uploaded to the MSS server(s) at step 514. The updated information is also updated in the CAS database 110 at step 514. The engine then waits for the MSS servers to indicate the update status at step 516. The MSS servers receive the update request at step 518, determines the cameras covered by the update at step 520 and enters a do-loop whereby each camera is updated at step 522 and confirming data is retrieved from the camera at step 524. The confirmation is compared to the request at step 526. If unsuccessful the camera update result is returned with a negative result at step 528; otherwise the next camera is selected for an update. When all cameras have been updated a camera update result with a successful result is sent in. The camera setting results are stored in the CAS database. The broadcast status log will be updated at step 530 and is the update is unsuccessful an error message is displayed at step 532.

The CAS controls VOD settings in a similar way. The change VOD settings sequence is selected at 540. The manufacturer list is populated at step 542. The time and date information for each manufacturer is selected at step 544. MSS servers to receive updates are displayed at step 546. If the list is correct then the user selects the update button at step 547 sends the updates to the MSS servers at step 548. The CAS then send the VOD settings to CAS database 110 and waits for a response from the MSS servers at step 550. Each MSS server receives the request at step 552, applies the new settings at step 554 and send a result message to the CAS server at step 556. The result report is then stored in the CASs database 110 at step 558. The camera setting results are stored in the CAS database. The broadcast status log will be updated at step 560 and is the update is unsuccessful an error message is displayed at step 562.

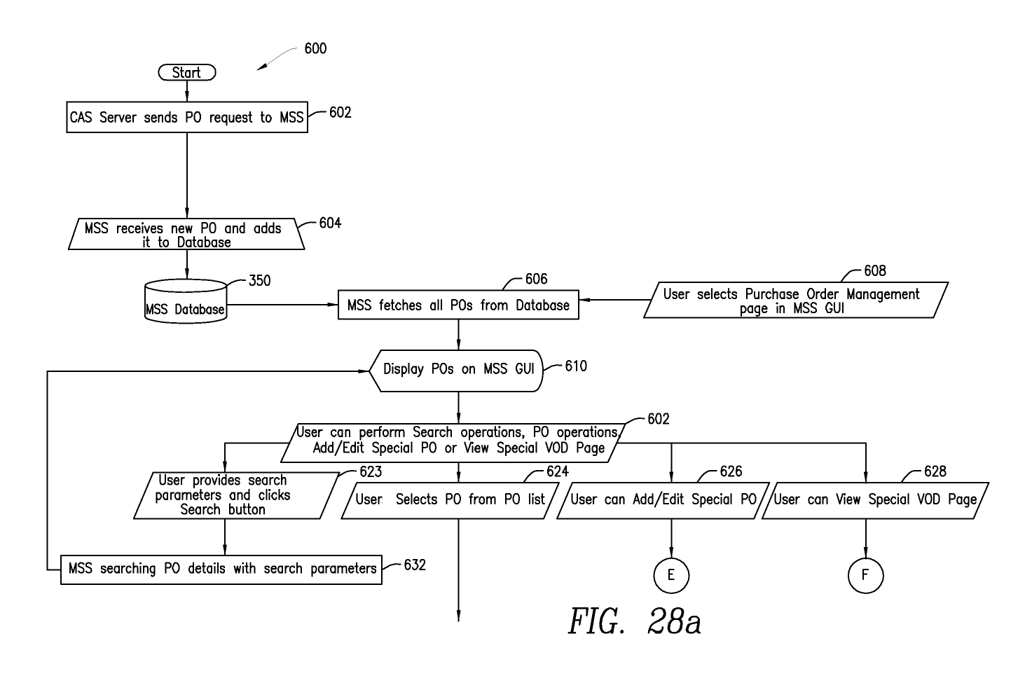

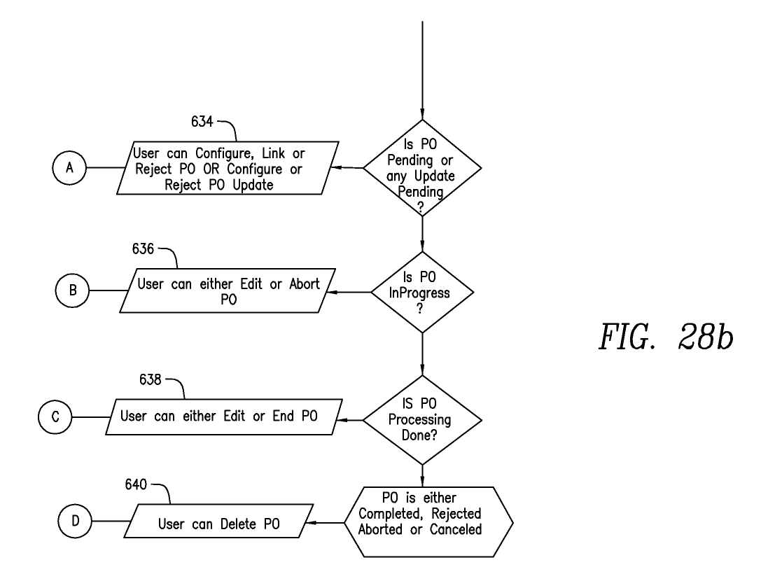

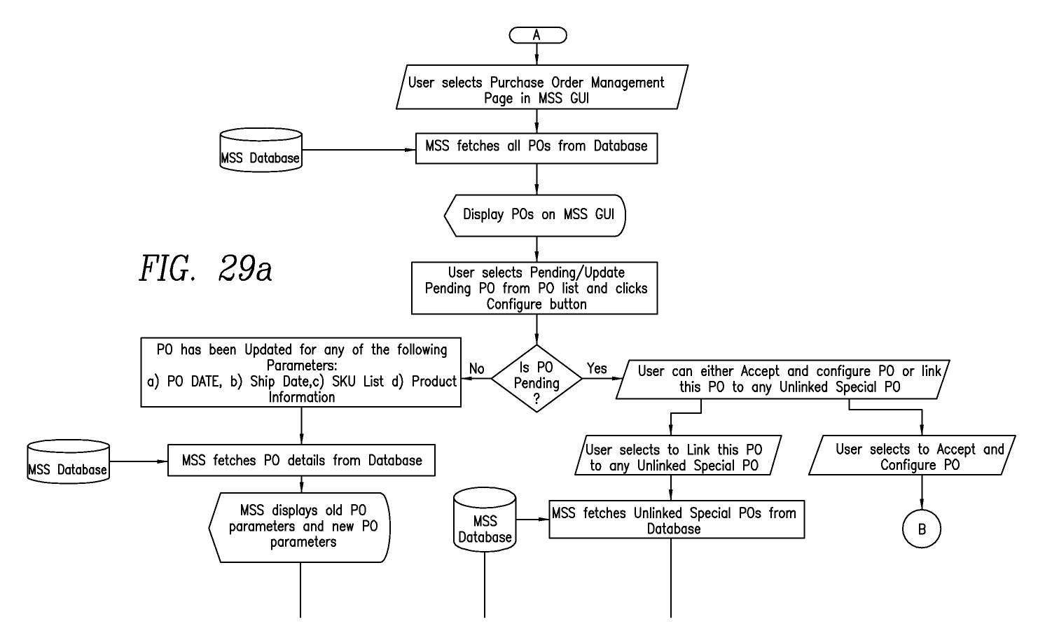

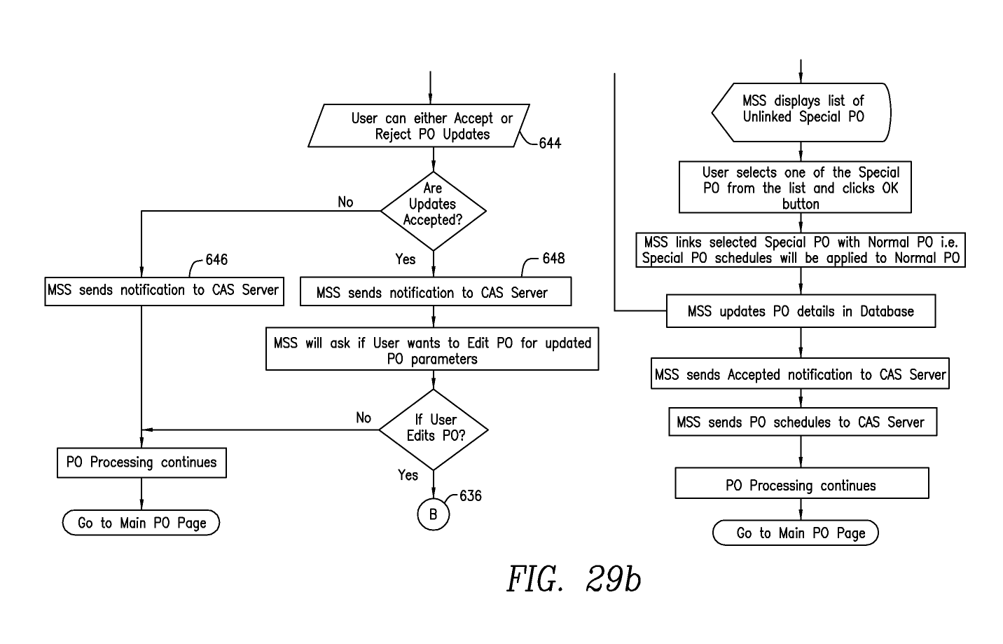

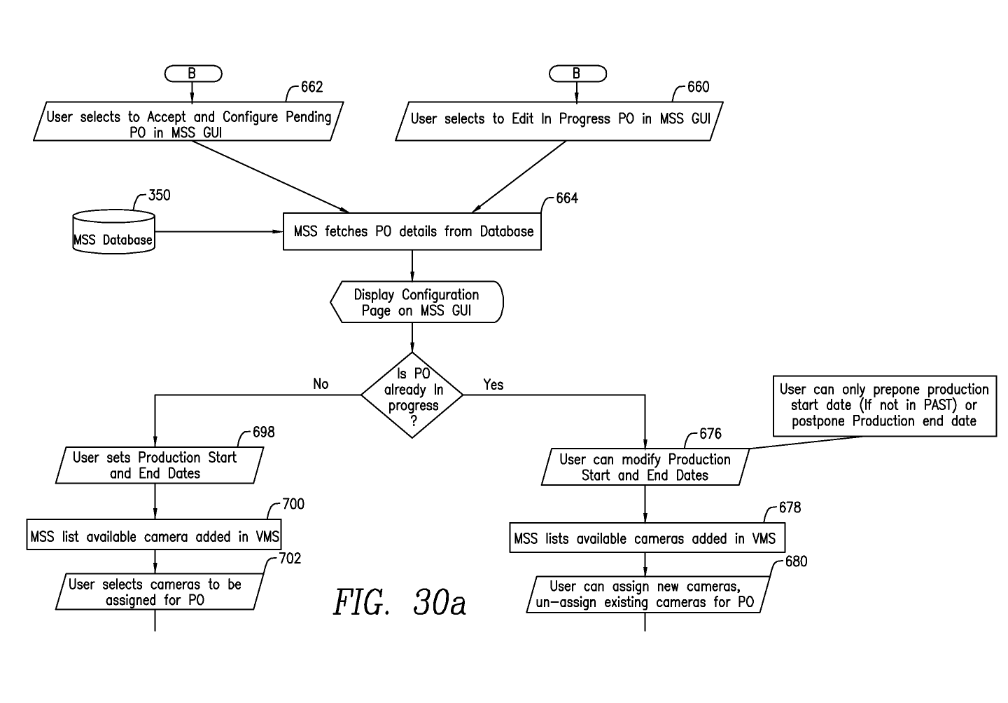

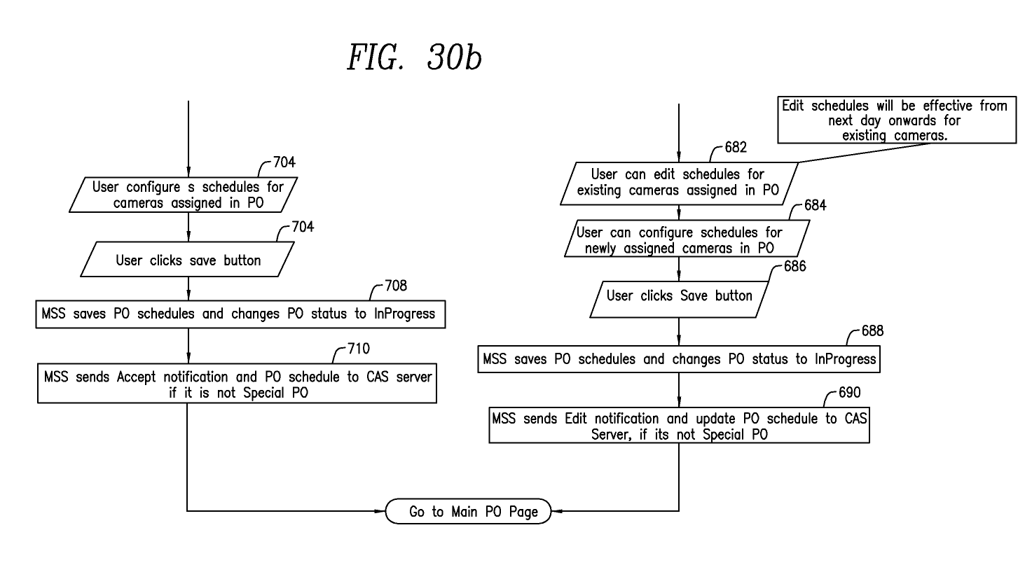

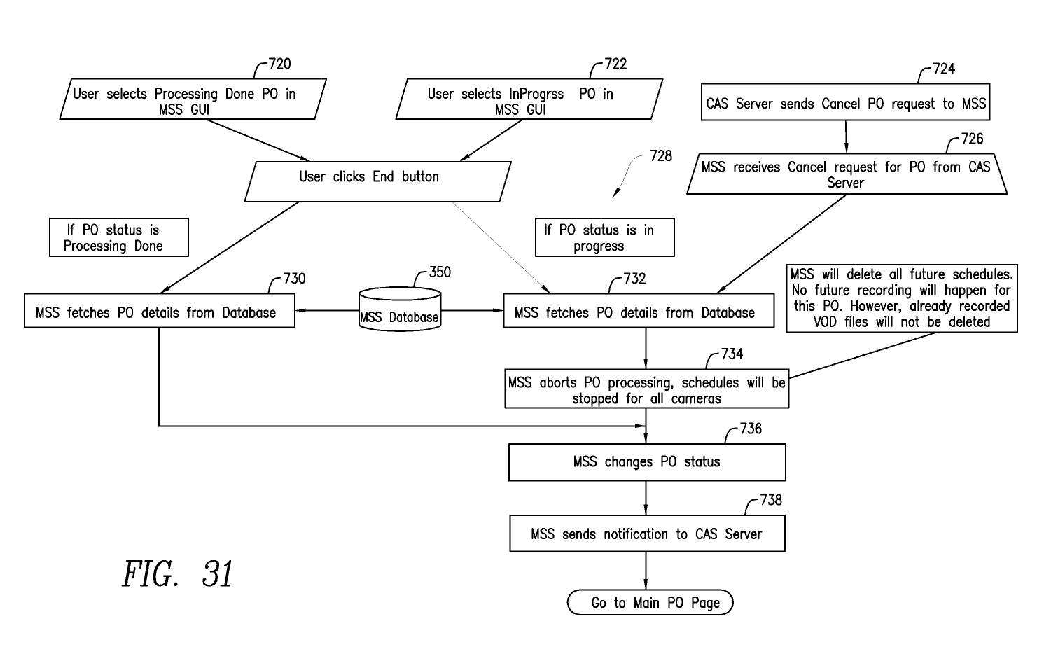

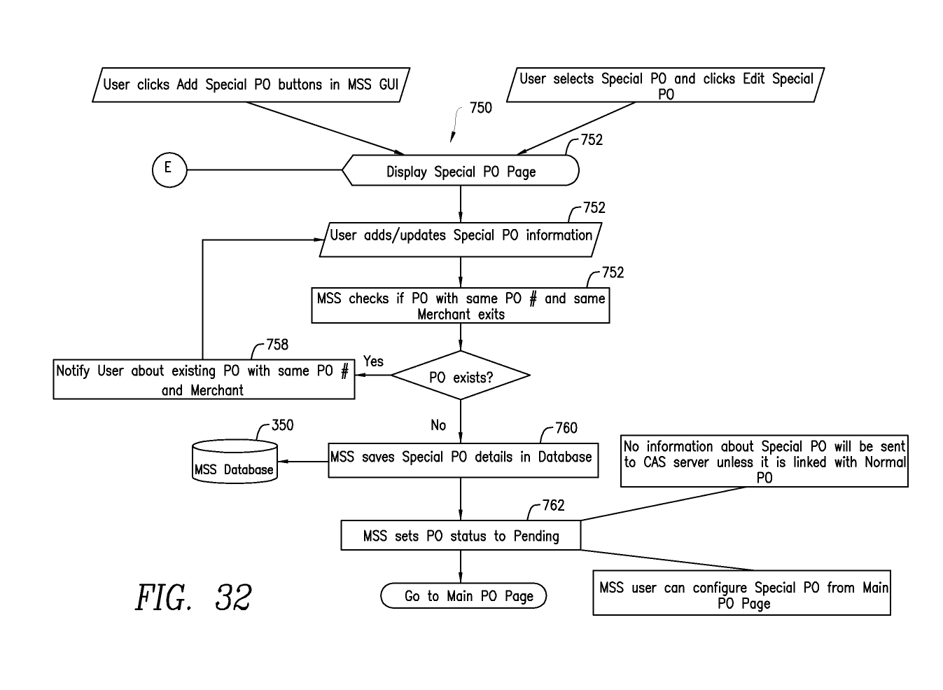

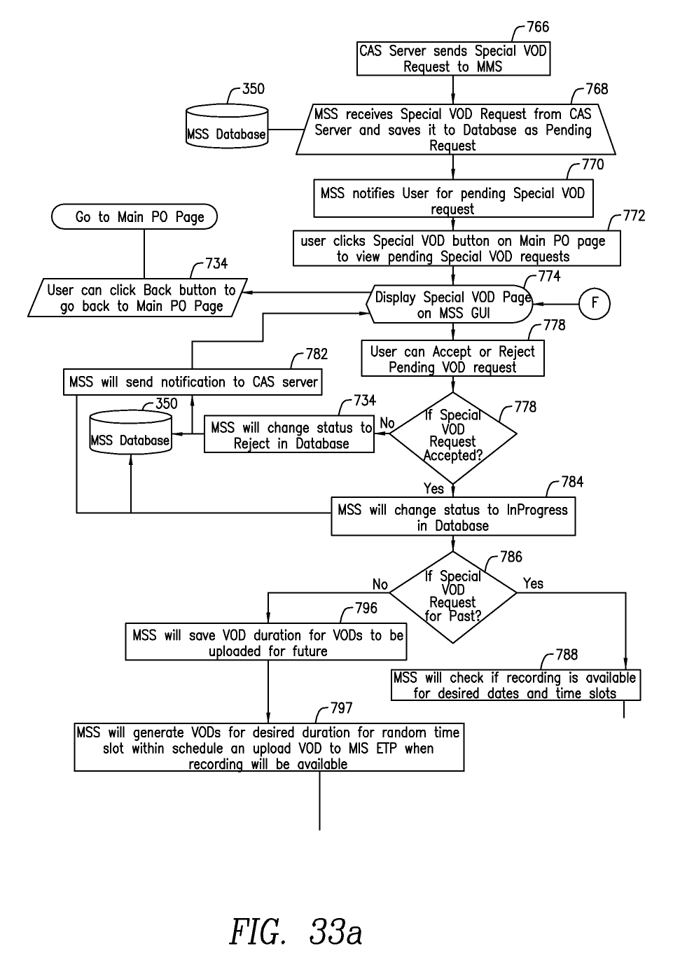

With reference to the MSS server 42 of FIG. 4, FIGS. 28-35 illustrate the presently preferred flow diagrams for the MSS server engines.

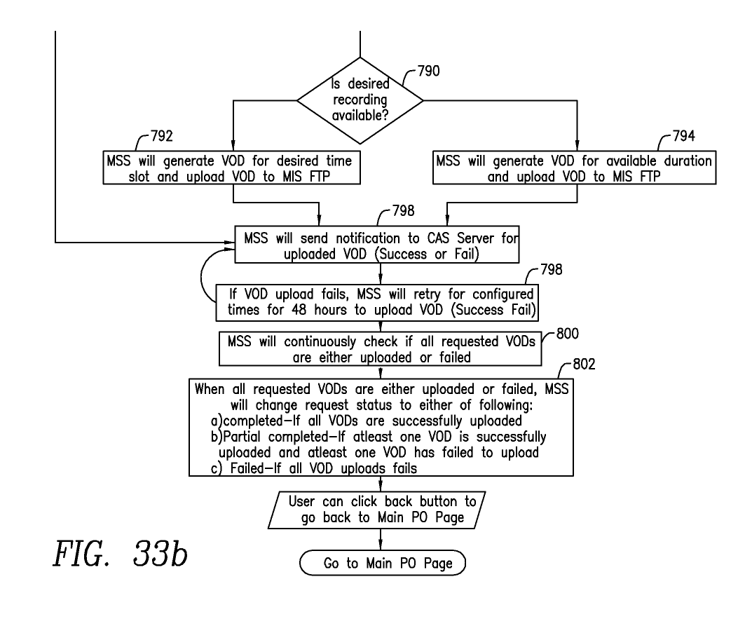

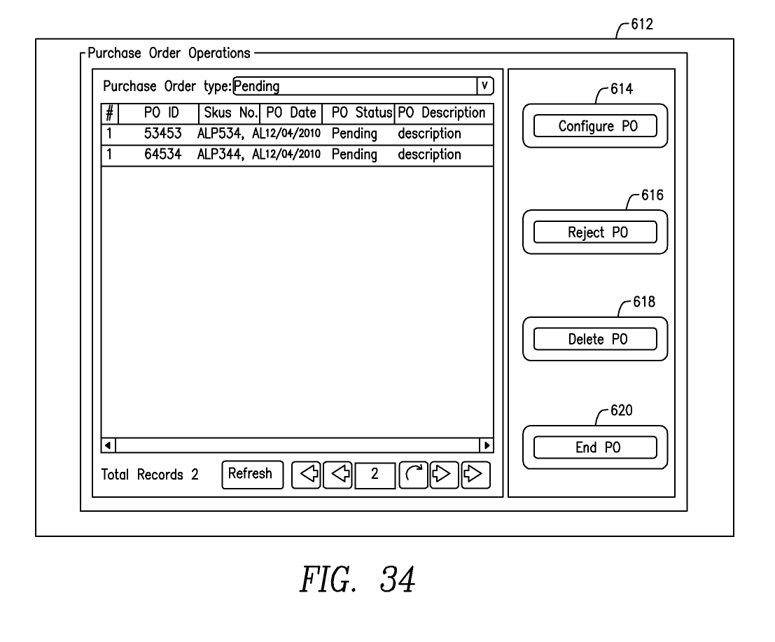

With reference to FIGS. 28a-b, 29a-b, 30a-b, 31, 32, and 33a-b, an embodiment of a purchase order request sequence 600 (FIG. 28a-b) for a Purchase Order Request Engine includes receiving a PO request from the CAS Server at step 602, upon receipt the MSS saves it to the MSS database 350 at step 604. In response to saving the PO request, an MSS server fetch POs from database request is made at step 606. This step can also be triggered by a user request at step 608. The POs are then displayed at step 610. A display screen 612 (FIG. 34) has a PO listing along with buttons for selecting PO configure 614, PO reject 616, PO Delete 618, and End PO 620. Furthermore, the columns in the list of POs include headers that can be selected to sort the POs according the ordering for that column. POs can be filter by PO order type and for long list they can be navigated, by a navigation bar 622. In connection with the PO display screen, the PO request sequence 600 includes sequences for searching POs at step 623, Selecting a PO from a list at step 624, Add/Edit special POs at step 626 and view special VOD requests at step 628.

In the case of search for POs at step 623, the user enters search parameters and selects <search> at step 630 to invoke a search engine at 632, where the search results are displayed at step 610. Selecting add/edit PO at step 626 invokes the sequence listed in FIG. 32. Selecting view special VOD request the VOD sequence listed in FIG. 33a-b. Selecting a PO from the list at step 624 allows for a filter of options for the PO based on the type of PO. If the PO is pending or has a pending update, then PO or PO update can be configured linked, rejected at step 634. If the PO is in progress, then the PO can be edited or aborted at step 636. If PO processing is done, then the PO can be edited or ended at step 638. If the PO is completed, rejected, aborted or canceled, then the PO can be deleted at step 640.

With regard to instances where the PO or PO update is pending (FIG. 29a-b), a configure pending PO sequence is implemented where pending updates may be accepted or declined at step 644. Depending on the choice, the CAS server is notified at steps 646 or 648. If the pending update is to be edited, then the edit PO at step 636 is chosen; otherwise, the engine stores the updates in the MSS database 350 and returns to the main menu.

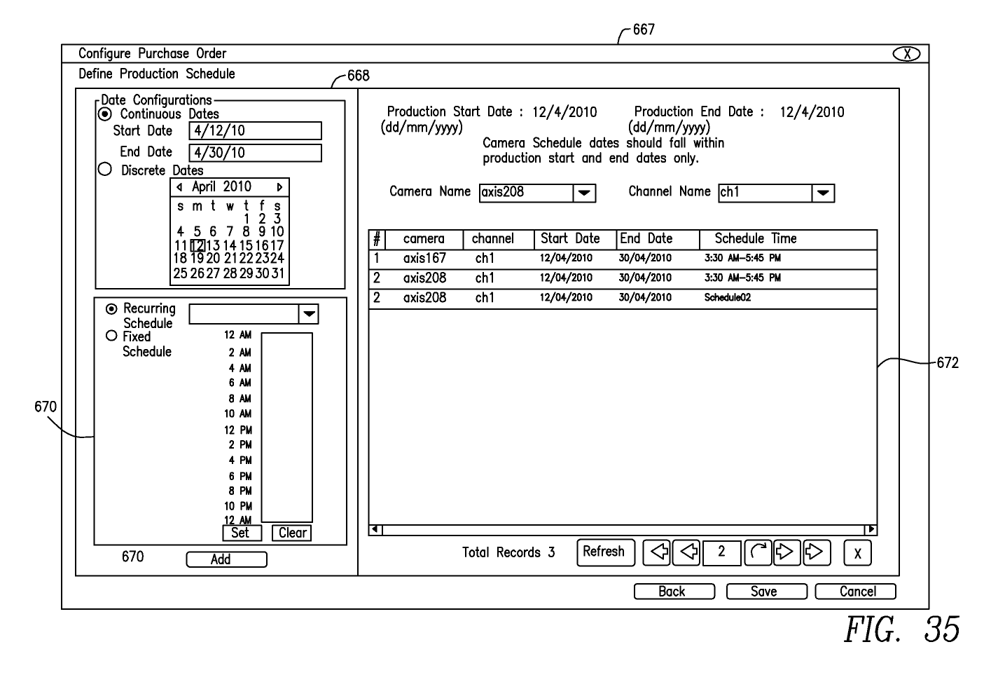

With regard to instances where the PO is in progress at step 660 or pending at step 662 (FIG. 30a-b), an edit PO edit sequence is initiated 664 with the PO information retrieved from the MSS database 350. A PO Edit screen of the type illustrated by FIG. 35, includes a date window 668, a scheduling window 670 and a camera listing window 672 for individual designation of camera schedules. The PO edit sequence branches depending upon whether the changes are to an in progress PO at steps 676-696 or not in progress PO at steps 698-710. Changes made in the latter case preserve the records for observations previously recorded prior to the changes. In each case the updates are saved to the MSS database 350 at steps 694 and 708 and the CAS server is notified of changes to non-special POs at steps 696 and 710.

With regard to instances where a completed or canceled PO at steps 720 and 722 (FIG. 31) or instances where the CAS server is canceling a PO at step 724 and it is received at step 726, the MSS server follows a cancelation and deletion sequence 728 where the PO information is retrieved at steps 730 and 732 from the MSS database 350. Where a purchase order is still in progress, the PO schedules are stopped for all future times at step 734. The status of the PO is changed in the MSS database indicating why it was stopped such as completed, canceled, rejected or aborted at step 736. The CAS server is notified of change at step 738.

An instance where a special PO request is made is handled by a special PO sequence 750 (FIG. 32), a screen similar to the PO edit screen (FIG. 35) is display and the user adds/edits the PO information at step 752. A check whether the PO already exists is made at step 754 and 756. If it exits the user is notified at step 758 and given an opportunity to back out the special PO sequence; otherwise, the special PO updates are made pending and saved at steps 760 and 762.

For POs with a special VOD request a special VOD request sequence is initiated at step 764 (FIG. 33a-b), the VOD request is sent by the CAS server at step 766 and the MSS server receives the request and saves it to the MSS Database 350 at step 768. The user is notified and can navigate to a window with the request at steps 770, 772 and 774, respectively. The MSS user can ignore or delay a decision on the request and navigate away at step 776 or confirm or reject the request at step 778. Where the user rejected the request, the request is changed to rejected and saved with the MSS database at step 780 and the CAS server is notified of the decision at step 782. Otherwise, where the user accepted the request, the request is changed to accepted and saved with the MSS database at step 784 and the CAS server is notified of the decision at step 782. A check is made at step 786 if the VOD times are for past recordings an automated search is made for past recordings 788 that satisfy either 790 all times 792 or partial times 794 and those files are sent to the MIS server. Otherwise, the VOD times will be scheduled 796 and recorded an uploaded to the MIS server. The MSS server will then notify the CAS server f a successful, partially successful or unsuccessful transfer. If data transfer was not successful the MSS will attempt to resend the files 798 for up to 48 hours while checking for successful transmissions 800. The status of the request is then saved and reported to the CAS server and MSS database 350 at step 802.

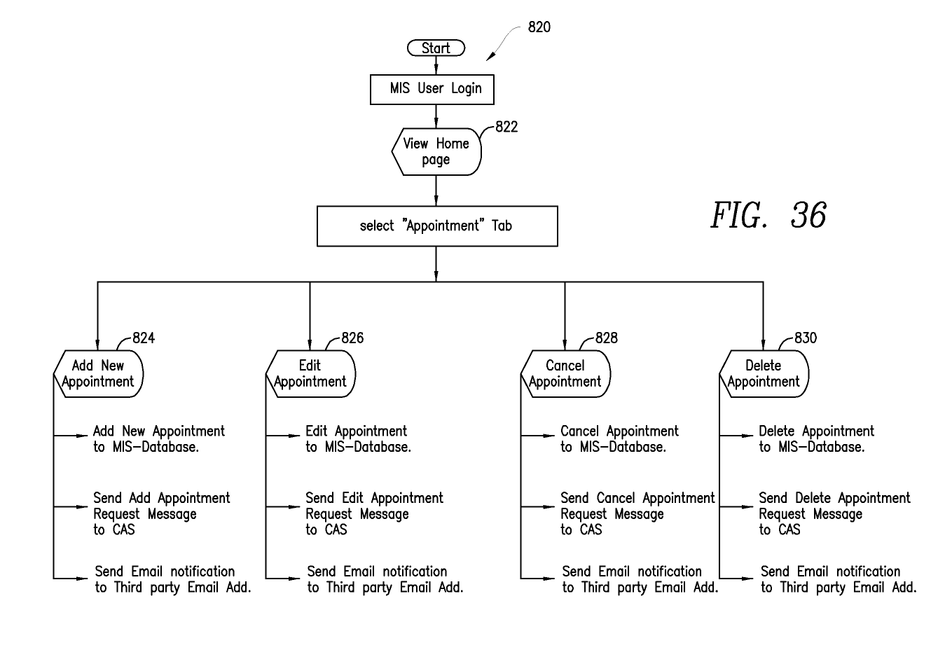

With reference to the MIS server 36 of FIG. 2, FIGS. 36-40 illustrate the presently preferred flow diagrams for the MIS server engines.

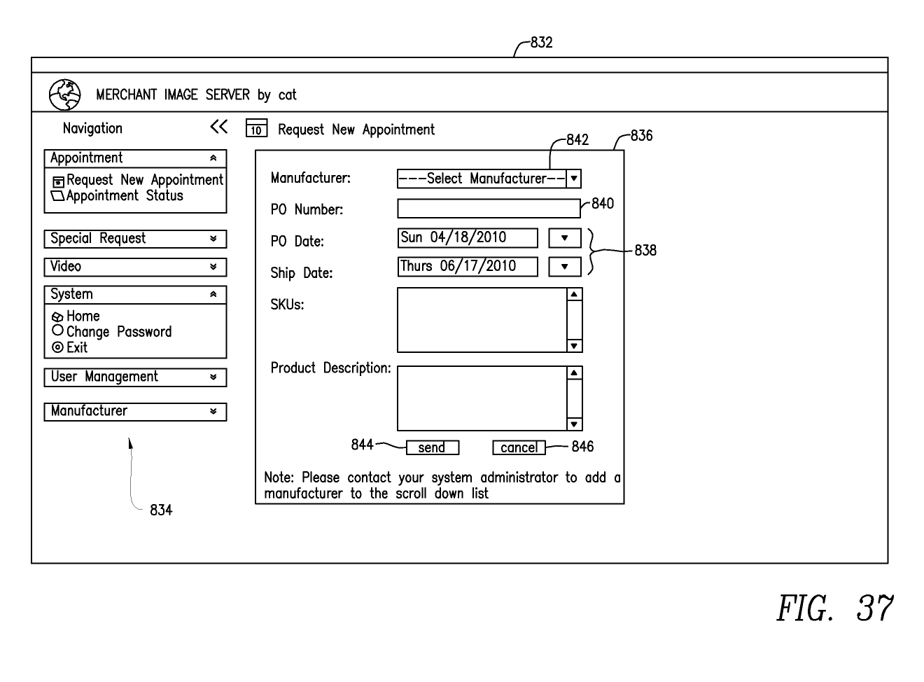

With regard to FIG. 36, a sequence for an appointment scheduling 820 in the configuration management engine includes an appointment menu 822 where the user can select to add a new appointment 824, edit an appointment 826, cancel an appointment 828 or delete an appointment 830. A screen 832 (FIG. 37) of the type suitable for this purpose includes a navigation window 834 and data entry window 836 for entry of dates 838, PO information 840, Manufacturer selection 842 with <send> 844 and <cancel> 846 buttons.

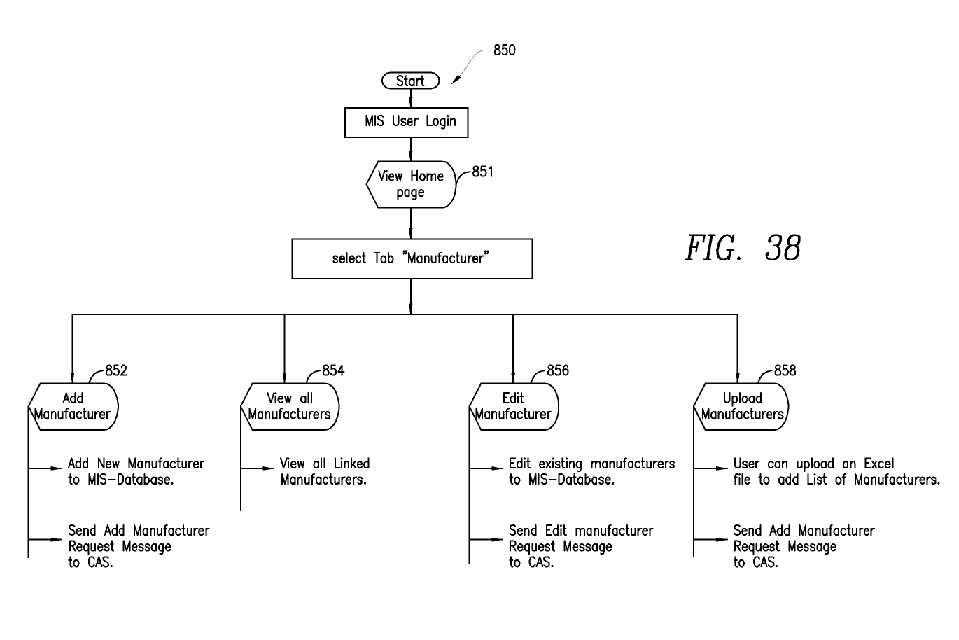

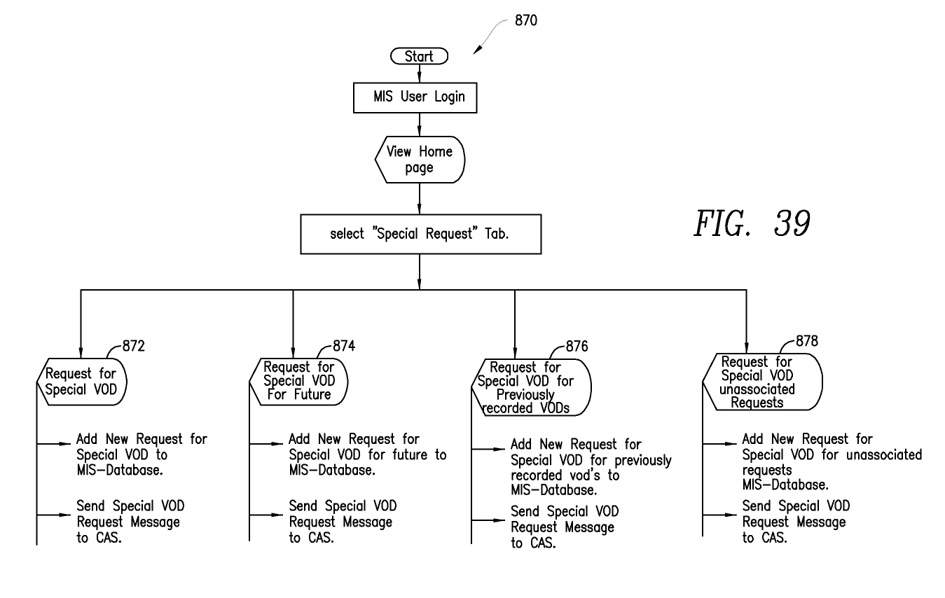

The MIS server users can also through the configuration management engine edit manufacturer information associated with the MIS server using a Manufacturer management sequence 850 (FIG. 38) in which the user can add a manufacturer 852, view existing manufacturers 854, edit manufacturers 856 and upload manufacturers from a list 858 such as a spreadsheet file.

For a special VOD request sequence 870 includes a for making special VOD requests from the MSS server. The MIS server can request a Special VOD 872, Request a VOD for future recording 874, Request a VOD of a past event 876 or make a VOD request unassociated with other scheduled recordings 878.

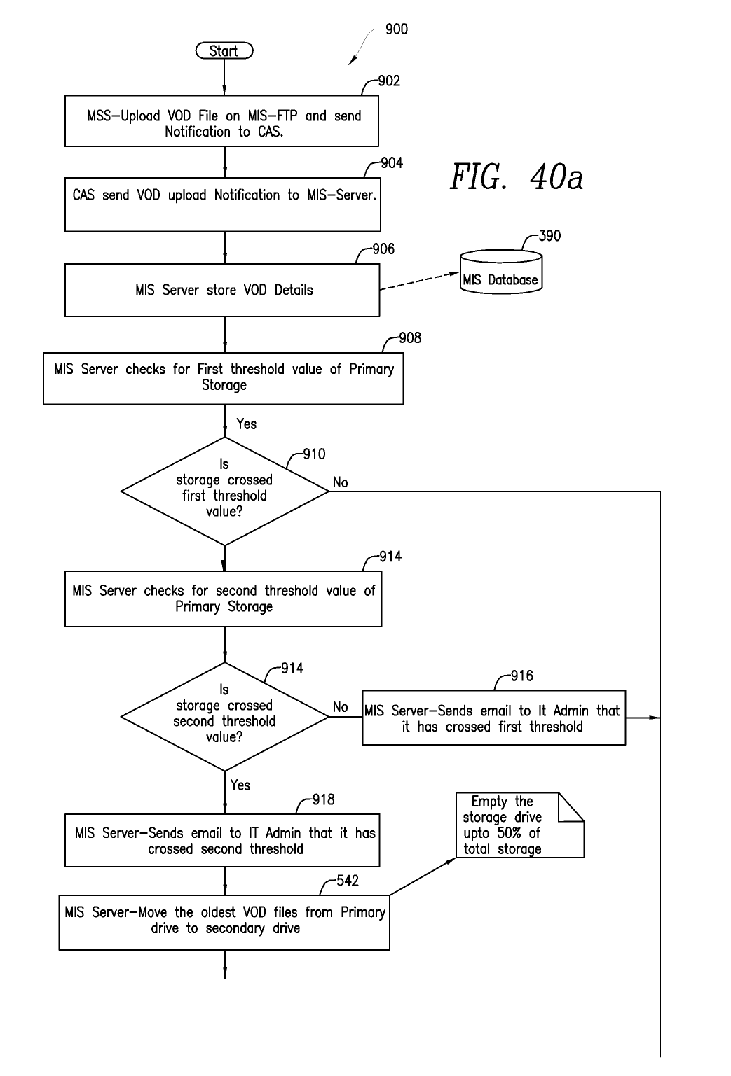

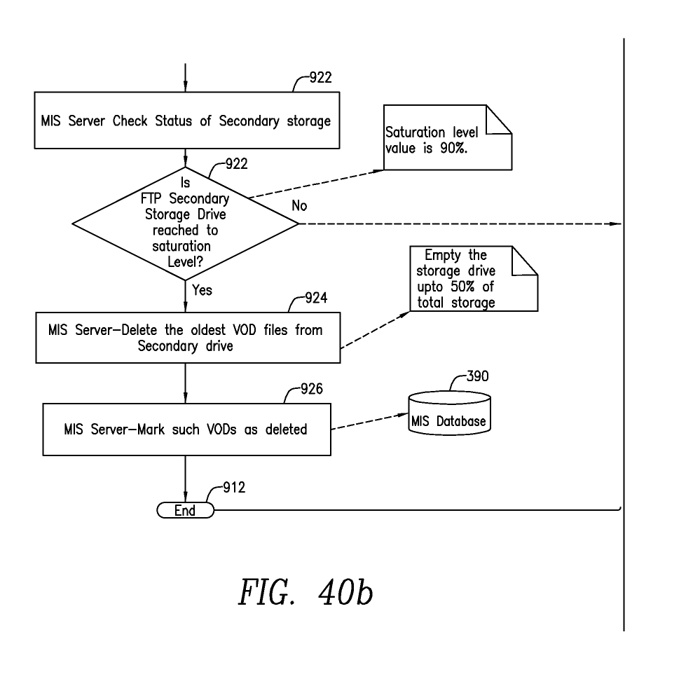

A unique feature of the present invention is the ability to use the third party CAS server for the direct transfer of video files, either live or previously recorded, from the MSS server directly to the MIS server. With reference to FIG. 40a-b, a VOD video transfer sequence 900 includes the MSS server indicating a file is ready for download 902 where the CAS server in-turn notifies the MIS server of a pending transfer 904 and the MIS receives the VOD files and stores the VOD file with the MIS database 390 at step 906. The MIS server monitors the MIS database for capacity overflow 908 and checks for a first threshold overflow 910 which may be some percentage of storage capacity set by the user or configured according to past daily file transfer volumes. If the first value is not satisfied download continues to the end 912; otherwise, then the MIS server check for a second threshold value 914. If not satisfied a message is sent to the administrator that capacity is getting full 916 and download continues to completion at step 912. If the second threshold is met, a message is sent to the administrator 918 and older VOD files are transferred to a secondary database at step 920. The secondary database is checked for capacity 922, if not full the transfers of older files freed space for the existing VOD download. Otherwise, space is made in the secondary database by deleting the oldest VOD files at step 924 and the MIS database 390 is updated with this information at step 926.

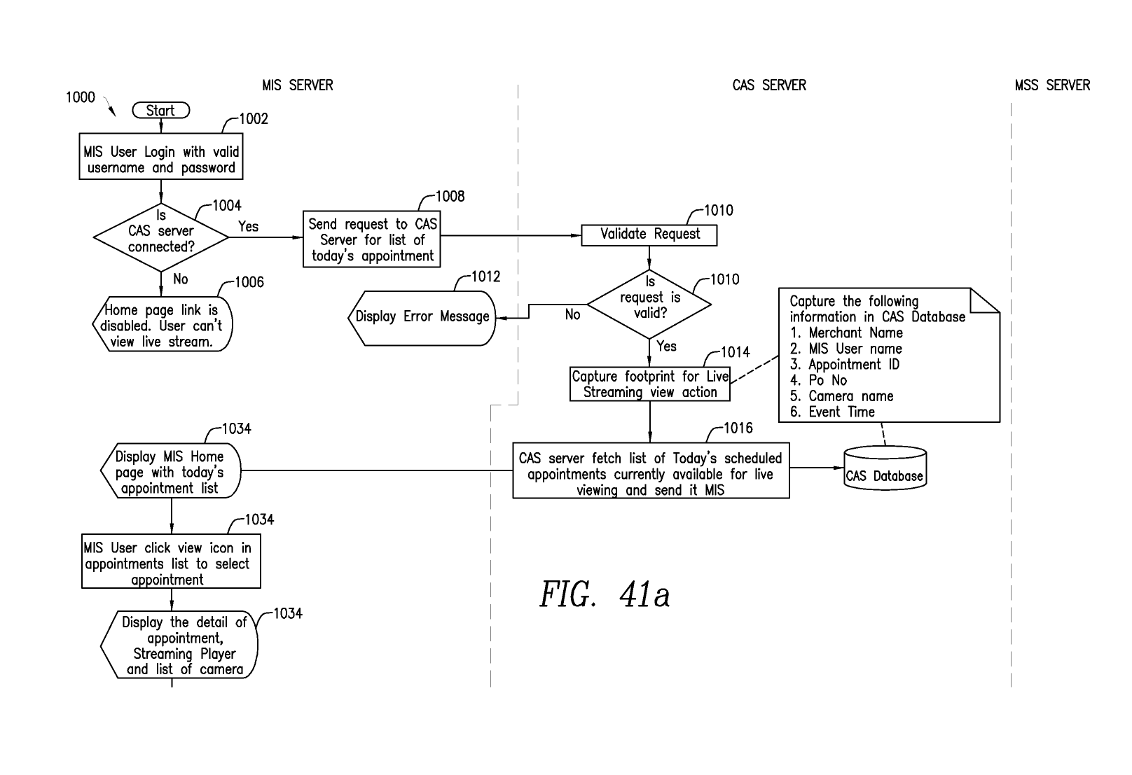

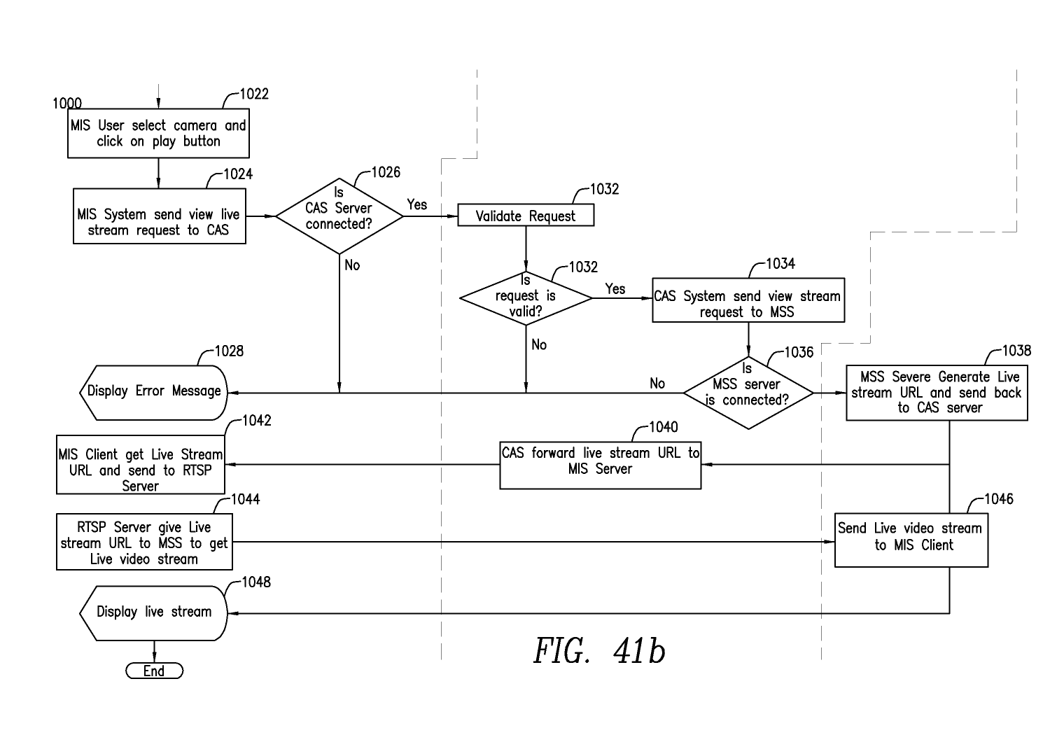

With regard to live video transfers, a live video transfer sequence 1000 (FIG. 41a-b) involves all three servers at the MIS, CAS and MSS facilities. First the MIS server logs in a viewer 1002 and checks that the MIS server and CAS servers are networked 1004. If down the MIS user is notified 1006, if it is on line the CAS server receives a live video request from the MIS user 1008 and checked for validity 1010. If not valid an error message is generated 1012; otherwise, the video criteria is loaded from the CAS database 1014 and the list of available live videos are sent to the MIS server 1016. The user views the live events for the day 1018 and selects a time 1020 and camera to view 1022. The MIS send the request to the CAS server 1024. A check is made that the CAS server is online 1026 and if not generates an error message 1028 otherwise the request is sent 1030 and validated 1032. If invalid an error message is sent to the MIS user 1028. Otherwise, the CAS Server sends a request to the MSS server 1034 and a check is made if the MSS server is on line 1036. If not, an error message is sent at 1028. Otherwise, the MSS server receives the request and generates a secure URL for the MIS user to view the live video 1038. The URL is forward to the CAS 1040 and then to the MIS server 1042. When the MIS user clicks on the URL during the live streaming time period 1044, the MSS server send the live streaming video to the MIS server 1046 and the MIS server displays the live video for the user 1048 while saving the live streaming video in the MIS database.

MCS Operations

For the purpose of this invention, those being observed in live or recorded video will be called the “observed” and those viewing video, live or recorded, will be called “clients”. One anticipated use of this technology relates to sellers and buyers, where sellers are the observed, possibly manufactures, and the buyers are the clients, possibly merchants, importers or distributors.

While surveillance systems already exist, and while “login” (FIG. 9) to gain entry to these systems is common, scheduled observation based on predefined appointment times, requested in a dynamic environment by the client and subject to confirmation or denial by the observed is a new and unique concept and will serve specific needs beyond the scope of the traditional surveillance industry. Furthermore, compliance and trust is assured by controlling such scheduling through a trusted server that is remote from both the client and the observed, namely, the CAS server.

MCS incorporates various security measures at all points of network/system access as well as at data (video and database information) storage locations (servers). This includes password and firewall protection. With reference to Figure, this screen shows the start of the process, with a client signing in to a secure server to request a viewing of his product throughout the production cycle. As will be seen, the request to view production will be based on a specific purchase order with a specific manufacturer.

With reference to FIG. 10, successful login to the system provides the client with a variety of options. The first allows them to create a request for a viewing.

The Merchant (client) completes the following Appointment/scheduling request form (FIG. 11). Upon completion it is sent to the manufacturer (observed) via the CAS server. Critical to system integrity, the CAS server will function as a validation point, confirming that all requests for all viewings are coming from authorized clients before the requests are forwarded to the appropriate facilities—the observed.

Just as client requests are sent through the CAS server for validation, appointment confirmations sent back from the observed will be forwarded to the clients after processing through the CAS server for validation. This will assure that key details related to the initial appointment request and the confirmation sent by the observed are in agreement and that the confirmation is in fact originating with an authorized system user. The CAS server will maintain a database of requested and confirmed appointments. Appointments not confirmed will be automatically resent by the CAS server after a prescribed period of time.

Appointment confirmations will include all relevant detail related to the observed, including specific information related to product and production lines as well as specific areas within the observed facility that will be available for viewing. The windows of opportunity or schedules to view live streaming video will be included in these confirmations as will a security code for the client to use, necessary to gain access to live video (FIG. 12). The same code will be used to access VOD (Video on Demand) which will be made available to the client to view in addition to live video (FIG. 13).

VOD will allow the client to view video at his convenience, even if an appointment to view live video is missed. VOD will be comprised of the same video, or some portion of the same video, that would have been available for live viewing. VOD will be stored as digital data on hard drives, using best practice methodologies to define the most efficient means of compression and storage. Best practice methods will also be used to determine most suitable compression and streaming options, with the ability for the system to evolve, taking advantage of new technologies as they become available, built into the system architecture.

This VOD screen shows what cameras are available for viewing and which dates recording took place. Access to VOD will be allowed with proper entry of the security code provided by the observed and validated through the CAS server. VOD will be indexed based on this security code, as well as other database tags which could include product descriptions, dates, factory names, and other possible search terms. These tags will allow clients to navigate large libraries of VOD, easily locating specific video clips saved in the database.

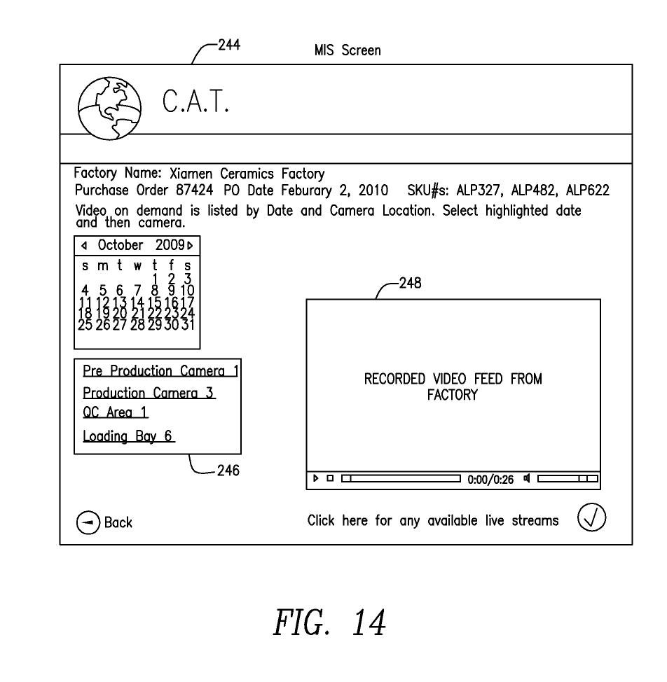

Servers used to contain VOD data or video libraries may be located at a clients facility or these servers can also be located off-site and remotely accessed. MCS will use scalable video playback, allowing the client to view more than one video playback window at a time, based on the systems detection of sufficient bandwidth (FIG. 14). This applies to both VOD and Streaming Live video. MCS will also detect available bandwidth, automatically adjusting picture quality (resolution) and frames per second to assure the best possible viewing experience, based on the resources available at any given moment, for both live and VOD.

The following example in FIG. 15 shows a screen for Live Video Streams. As with VOD, these streams would be made available to the client based on the proper entry of a security code provided by the observed. In this case, the observed is a factory and the Client is the buyer of a product being manufactured for him at the factory. AS with VOD, available live video is indexed according to the security code.

A core component of MCS is the scheduling component used by the observed (in this example, a manufacturer). The observed completes the following screen based upon the clients (in this example, a retail chain) appointment/schedule request form as shown in FIG. 16. An Auto confirmation is sent to the merchant upon completion via the CAS server and cameras are also automatically allocated for both streaming and uploading of video on demand based on the Observed completion of the scheduling form. Video will be recorded and stored, for the use of the observed, at all times and from all cameras based on the needs and desire of the observed. However, only video specifically assigned by the viewing appointment will be made available to the client, either as VOD or Live streaming video. With the completion of this form, the Observed triggers the automated MCS processing of the viewing appointment confirmation, the assignment of recording cameras, storage needs, and all other resources required for system functionality.

Alarms, Analytics and Reporting

Alarm notifications are a preferred feature of the MCS system. The observed party must confirm a scheduled appointment. However, once confirmed the CAS server will track the appointment to determine if it was completed successfully.

A successful appointment is one where the resources committed to in the confirmation of the appointment were made available to the client. To further clarify, a successful appointment results when, live and recorded video was available to the Client at the correct times, from the correct cameras, based on the confirmation.

Alarms are triggered if an appointment is not initiated as per the confirmed schedule. Alarms are triggered if the appointment is interrupted or not completed. The alarms will, to the extent technologically possible be reported as to their cause for failure to initiate and complete the appointment. Examples of causes could include, power outages, inoperable video equipment or other hardware, lack of internet or other means of transmission of video.

Alarms will also be triggered by the tampering with the system put in place at the observed location. This includes tampering with software provided to the observed or time stamps which authenticate the actual date and time of the live video and the time the VOD was recorded.

An Alarm will also be triggered if the client tampers with the software provided as part of the MCS system.

In summary, any condition that will adversely affect the function of the system, hampering the ability of a scheduled viewing to take place—live or VOD, will trigger an alert notification (alarm) which will be sent to the CAS server. The MCS system will include diagnostic tools to verify alarm codes and help to determine the cause of faults, errors, or outages. Diagnostic tools will also be used to identify any tampering with hardware components connected to the MCS system or an attempt to tamper with the MCS software architecture.

The MCS System also will provide reporting functions. It will collect data on usage of the MCS system by all parties as well as data on alarms. The MCS system will report the frequency and types of alarms/alert notifications at an observed location and compare the frequency with other observed parties.

In addition to basic reporting, statistical analysis of peak usage, most frequent users, client comparisons, time on line and other information that can be used to improve the functionality of MCS will be made available in reports generated by CAT.

Analytics will also be performed utilizing the MCS system to determine Quality and the meeting of standards. Standards may include, color, size, shape, motion, and allowable tolerances within a set range of specifications. These analytics can be obtained using data collected from video cameras as well as other data collection and measuring devices used for these purposes. All analytics relevant to and requested by a client, and made available by the observed, will be included within CATs graphic user interface as well as be recorded locally by the observed for their own internal use.

Usage and Benefits

The examples are related to buyers and sellers with one likely application, as shown, for importers, distributors, and/or retailers, purchasing directly from Factories, domestically or internationally, to observe their products as they move through the entire production cycle, from the earliest stages to packaging and even container load outs.

While there are existing networks and systems that allow remote observation of factory production lines or other facilities, MCS is unique and provides solutions to real problems that were not available prior to CAT. The significant differences that the MCS system provides can best be described by the benefits both Clients and the observed will enjoy when employing MCS.

Confidentiality of the facilities (observed) proprietary techniques and systems can be maintained by allowing specific clients to view only selected areas, related to specific production orders, and specific times. This is accomplished through the CAS Scheduling and Resource Allocation Component which allows production cycles to be associated with client purchase orders and related requests to view the production cycle, automatically managed by CAS based on the viewing confirmation submitted by the observed. If one thinks of a viewing as a “virtual visit” and then compare this “virtual visit” to an actual visit to a facility, CAS provides the means to discreetly guide the visitor of the facility to areas open to view, while not allowing the visitor into high security or private areas. Both the observed and the client benefit from this control. In this way, not only are the observed concerns of confidentiality addressed but clients that often work with the same facilities, sharing the same suppliers, factories, or facilities (observed), need not fear that their exclusive designs or proprietary concepts can be viewed by their competition. Of course, in typical surveillance situations, the observed would not have this degree of control, if any.

With the CAS server, acting as portal for both the client and the observed, security of the system is maintained while all users' requests and confirmations are validated.

The above example illustrates a buyer and a seller, with the buyer observing production. For clients, beyond the benefit of secure observation of a facility the buyer (client) will be able to determine specific compliance agreements are being adhered to. This may relate to the product itself and the need to maintain a specific standard related to quality or other specification. Compliance issues can also relate to social issues such as work conditions and child labor. The MCS system will also allow for confirmation of compliance adherence related to packing methodology and packaging as well as container load outs, carton markings, and many other components of a purchase agreement that can be widely referred to as compliance.

In addition to buyer and seller relations, the MCS system can be used in many other applications as well. Thus, the use of the terms ‘Merchant’ and ‘Manufacturer’ are not to be interpreted as limiting, but merely exemplary of a currently preferred embodiment. As presently presented this system can be used in any situation relating to the compliance of goods or services. A grade school environment is a good example. Privacy concerns shared by parents and a school would not typically allow for live video or VOD Observation by Parents. The MCS system provides educators with a system that allows them to invite specific parents, at specific times, to view their children at work or to watch special activities or programs. Parents would be registered and validated through the CAS server to assure they were authorized to view a specific activity or classroom.

In the case of an emergency situation, while a school may not feel comfortable with LIVE Video made available at all times to outside agencies, MCS could be programmed to respond to emergency situations, providing live Video or VOD feeds to pre-registered law enforcement or other emergency first responders based on case by case authorization provided by the schools administrators.

Another use of the MCS system relating to Education is its ability to schedule and manage remote location university class audits. Students considering a new university or a class at a university they may already be attending could request and be given permission to view specific lectures at specific times. Data collected by the CAS server could allow administrators to evaluate a specific curriculums popularity while also identifying new or existing students, giving educators information they need to properly follow-up with these students.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A system comprising:
at least one image system located at a client facility for observing a facility;
a surveillance system in network communication with said image system and located at said facility to be observed;
a compliance assurance system having a server independent of, but in network communication with the client facility and facility to be observed; and
said compliance assurance system coordinates agreement for scheduling observation times between said image system and said surveillance system.

2. The system of claim 1 wherein said compliance assurance system includes a database for tracking the information related to the image system and the surveillance system including video availability and recording times.

3. The system of claim 2 wherein said compliance assurance system includes an engine for authenticating and authorizing new surveillance requests from said at least one image system and requesting an acceptance or rejection from the surveillance system for such requests.

4. The system of claim 1 wherein said compliance assurance system further includes a merchant management engine for setting up and authorizing at least one image system for at least one client facility.

5. The system of claim 4 wherein said compliance assurance system further includes a manufacturer management engine for setting up and authorizing at least one surveillance system for at least one facility to be observed.

6. The system of claim 5 wherein said compliance assurance system further includes a manufacturer link/unlink engine for authorizing communication between at least one image system for at least one client facility and at least one surveillance system for at least one facility to be observed.

7. The system of claim 1 wherein said compliance assurance system includes an engine for setting surveillance devices associated with said surveillance system.

8. The system of claim 7 wherein said surveillance devices include cameras.

9. The system of claim 1 said compliance assurance system includes a video on demand settings engine for receiving video requests from said at least one image system and receiving an acceptance or rejection from said surveillance system.

10. The system of claim 1 wherein said surveillance system includes an engine for managing purchase order requests from said at least one image system via said compliance assurance system.

11. The system of claim 10 wherein said engine for managing purchase order requests includes managing changes to purchase order requests.

12. The system of claim 10 wherein said engine for managing purchase order requests includes rejecting purchase order requests.

13. The system of claim 10 wherein said engine for managing purchase order requests includes identifying that purchase order requests are completed.

14. The system of claim of claim 1 wherein said at least one image system includes an engine for requesting a new surveillance appointment with said surveillance system through said compliance assurance system.

15. The system of claim 6 wherein a plurality of said at least one image systems are included in said system.

16. The system of claim 15 wherein a plurality of said surveillance systems are included in said system.

17. The system of claim 16 wherein any of said plurality of said at least one image systems are linked to any of said plurality of said surveillance systems.

18. The system of claim 1 wherein video streaming between said image system and said surveillance system is first approved and authenticated by said compliance assurance system and then responsibility for said streaming video is handled between said image server and said surveillance server.

19. A manufacturing compliance system comprising:
an image system located at a client facility for observing a facility;
a surveillance system in network communication with the image system to deliver video and located at a facility to be observed;
a compliance assurance system having a server independent of, but in network communication with, the client facility and facility to be observed; and
wherein scheduled observation based on predefined appointment times, requested through the compliance assurance system by a client and subject to confirmation or denial by said facility.

20. A system comprising:
at least one image system located at a client facility for observing a facility;
a surveillance system in network communication with said image system and located at said facility to be observed;
a compliance assurance system having a server independent of, but in network communication with the client facility and facility to be observed;
said compliance assurance system coordinates agreement for scheduling observation times between said image system and said surveillance system;
wherein said compliance assurance system includes a database for tracking the information related to the image system and the surveillance system including video availability and recording times;
wherein said compliance assurance system includes an engine for authenticating and authorizing new surveillance requests from said at least one image system and requesting an acceptance or rejection from the surveillance system for such requests;
wherein said compliance assurance system further includes a merchant management engine for setting up and authorizing at least one image system for at least one client facility;
wherein said compliance assurance system further includes a manufacturer management engine for setting up and authorizing at least one surveillance system for at least one facility to be observed; and
wherein said compliance assurance system further includes a manufacturer link/unlink engine for authorizing communication between at least one image system for at least one client facility and at least one surveillance system for at least one facility to be observed.
